(19) United States
(12) Patent Application Publication
(10) Pub. No.: US 2024/0305617 A1
(43) Pub. Date: Sep. 12, 2024

(54) SERVICE PROCESSING APPARATUS, SYSTEM, METHOD, AND COMPUTER READABLE MEDIUM

(71) Applicant: NEC CORPORATION, Tokyo (JP)

(72) Inventors: Taichi OKUMURA, Tokyo (JP); Tatsuki AKUTSU, Tokyo (JP); Noriyuki HIRAMOTO, Tokyo (JP)

(73) Assignee: NEC CORPORATION, Minato-ku, Tokyo (JP)

(21) Appl. No.: 18/574,910

(22) PCT Filed: Jul. 9, 2021
(86) PCT No.: PCT/JP2021/026003

§ 371 Date: Dec. 28, 2023

(51) Int. Cl. H04L 9/40

(52) U.S. Cl. CPC H04L 63/08

(57) ABSTRACT

A service processing apparatus includes: an authentication control unit that refers to a database in which identity authentication information of affiliated members of a partner organization of a business operator who provides a predetermined service in a predetermined facility is registered, and controls authentication that is performed based on identity authentication information of a user of the facility acquired by an authentication terminal installed in the facility; a specifying unit that specifies an organization to which the user belongs based on a fact that the authentication has succeeded; a determination unit that determines a service that the business operator provides according to the specified organization; and a processing unit that performs processing according to the determined service.

### TECHNICAL FIELD

The present invention relates to a service processing apparatus, a system, a method, and a program. In particular, the present invention relates to a service processing apparatus, a system, a method, and a program for providing a service to a user.

### BACKGROUND ART

In recent years, it is becoming an increasingly common practice for business operators who provide services to authenticate whether or not a user is a qualified person, i.e., a member of some organization or the like who has been registered in advance, and then to provide a predetermined service when it is authenticated that the user is a qualified person.

Patent Literature 1 discloses a technology related to an authentication system in which qualification information to be authenticated and face information of a legitimate person having a qualification are registered in a server. In this authentication system, a dedicated terminal provided on the side of a person (or an organization) who perform authentication acquires qualification information and a face image from the server, compares the acquired face image with the face image of a person to be authenticated, and when they match each other and the qualification is valid, grants permission to the person to be authenticated.

### CITATION LIST

### Patent Literature

Patent Literature 1: Japanese Unexamined Patent Application Publication No. 2020-038684

### SUMMARY OF INVENTION

### Technical Problem

There is a problem that it is difficult for a business operator like the one described above to independently collect and manage membership information including authentication information (identity authentication information or the like) in order to authenticate whether or not a person of interest is a qualified person.

In view of the above-described problem, an object of the present disclosure is to provide a service processing apparatus, a system, a method, and a program for enabling a business operator who provides services to provide an appropriate service to an affiliated member or the like of a partner organization while facilitating management of membership information of affiliated members or the like of the partner organization.

### Solution to Problem

A service processing apparatus according to a first aspect of the present disclosure includes:
authentication control means for referring to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
specifying means for specifying an organization to which the user belongs based on a fact that the authentication has succeeded;
determination means for determining a service that the business operator provides according to the specified organization; and
processing means for performing processing according to the determined service.

A service processing system according to a second aspect of the present disclosure includes:
a database in which identity authentication information of affiliated members of a partner organization of a business operator who provides a predetermined service in a predetermined facility is registered; and
an authentication terminal installed in the facility; and
a service processing apparatus, in which
the service processing apparatus includes:
authentication control means for referring to the database and controlling authentication that is performed based on identity authentication information of a user of the facility acquired by the authentication terminal;
specifying means for specifying an organization to which the user belongs based on a fact that the authentication has succeeded;
determination means for determining a service that the business operator provides according to the specified organization; and
processing means for performing processing according to the determined service.

A service processing method according to a third aspect of the present disclosure includes:
referring, by a computer, to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
specifying, by the computer, an organization to which the user belongs based on a fact that the authentication has succeeded;
determining, by the computer, the service that the business operator provides according to the specified organization; and
performing, by the computer, processing according to the determined service.

A service processing program according to a fourth aspect of the present disclosure causes a computer to perform:
a process for referring to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
a process for specifying an organization to which the user belongs based on a fact that the authentication has succeeded;
a process for determining a service that the business operator provides according to the specified organization; and a process for performing processing according to the determined service.

### Advantageous Effects of Invention

According to the present disclosure, it is possible to provide a service processing apparatus, a system, a method, and a program for enabling a business operator who provides services to provide an appropriate service to an affiliated member or the like of a partner organization while facilitating management of membership information of affiliated members or the like of the partner organization.

### BRIEF DESCRIPTION OF DRAWINGS

FIG. 1 is a block diagram showing a configuration of a service processing apparatus according to a first example embodiment;

FIG. 2 is a flowchart showing a flow of a service processing method according to the first example embodiment;

FIG. 3 is a block diagram showing an overall configuration of a service processing system according to a second example embodiment;

FIG. 4 shows an example of a configuration of an airline company member DB according to the second example embodiment;

FIG. 5 shows an example of a configuration of a partner company employee DB according to the second example embodiment;

FIG. 6 is a block diagram showing a configuration of an authentication terminal according to the second example embodiment;

FIG. 7 is a block diagram showing a configuration of an authentication apparatus according to the second example embodiment;

FIG. 8 is a block diagram showing a configuration of a service processing apparatus according to the second example embodiment;

FIG. 9 is a flowchart showing a flow of an employee information registration process according to the second example embodiment;

FIG. 10 is a flowchart showing a flow of a face information registration process performed by an authentication apparatus according to the second example embodiment;

FIG. 11 is a sequence diagram showing a flow of a partnership registration process according to the second example embodiment;

FIG. 12 is a flowchart showing a flow of a service providing process according to the second example embodiment;

FIG. 13 is a flowchart showing a flow of a face authentication process performed by an authentication apparatus according to the second example embodiment;

FIG. 14 shows an example of a notification information display screen image according to the second example embodiment;

FIG. 15 shows an example of a notification information display screen image according to the second example embodiment;

FIG. 16 shows an example of a notification information display screen image according to the second example embodiment;

FIG. 17 shows an example of a notification information display screen image according to the second example embodiment;

FIG. 18 shows an example of a notification information display screen image according to the second example embodiment; and

FIG. 19 shows an example of a notification information display screen image according to the second example embodiment.

### EXAMPLE EMBODIMENT

An example embodiment according to the present disclosure will be described hereinafter in detail with reference to the drawings. Components corresponding to or the same as each other are assigned the same or corresponding numerical numbers (or symbols) throughout the drawings, and redundant descriptions thereof are omitted as appropriate for clarifying the explanation.

### First Example Embodiment

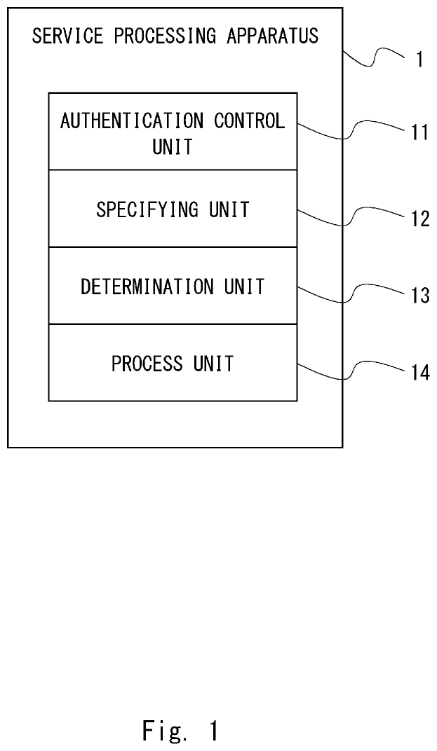

FIG. 1 is a block diagram showing a configuration of a service processing apparatus 1 according to a first example embodiment. The service processing apparatus 1 is an information processing apparatus for performing a process for a service that a predetermined business operator provides to an affiliated member of a partner organization of the business operator in a predetermined facility according to the organization.

In the first example embodiment, a database connected to the service processing apparatus 1 and an authentication terminal installed in the facility are used as components/structures that are not shown in the drawing. This database is one in which identity authentication information of affiliated members of the partner organization of the business operator who provides a predetermined service in the predetermined facility is registered. Note that the “organization” is a corporation, a group, or the like to which a plurality of affiliated members (members or the like) belong. The “identity authentication information” is information used for the authentication of an identity of a person, and is information for uniquely specifying (identifying) an identity of a person. The identity authentication information is, for example, biometric information, information about an identification card, or display information in which an individual number is coded. However, the identity authentication information is not limited to this example. Further, the authentication terminal acquires identity authentication information from a user of the facility and transmits the acquired identity authentication information to the service processing apparatus 1.

The service processing apparatus 1 includes an authentication control unit 11, a specifying unit 12, a determination unit 13, and a processing unit 14. The authentication control unit 11 refers to the above-described database and controls authentication that is performed based on the identity authentication information of the user of the facility acquired by an authentication terminal installed in the facility. For example, when the service processing apparatus 1 holds the identity authentication information for authentication in advance, the authentication control unit 11 performs the authentication process by comparing the held identity authentication information with the acquired identity authentication information. Alternatively, when the identity authentication information for authentication is stored in an external authentication apparatus, the authentication control unit 11 makes (e.g., instructs) the authentication apparatus perform an authentication process and acquire the result of the authentication (hereinafter also referred to as an authentication result).

The specifying unit 12 specifies an organization to which the user belongs based on the fact that the authentication has succeeded. For example, when the authentication by the authentication control unit 11 has succeeded, it means that the identity authentication information, which has been used for the successful authentication, is registered in the aforementioned database, so that the specifying unit 12 can then specify (i.e., determine) that the user, for whom the authentication has succeeded, belongs to the aforementioned organization. Therefore, the specifying unit 12 can specify the organization to which the user, for whom the authentication has succeeded, belongs.

The determination unit 13 determines a service that the business operator will provide according to the specified organization. For example, the determination unit 13 may determine a service content and a service level according to the details of a contract between the organization and the business operator. The processing unit 14 performs processing according to the determined service. For example, the processing unit 14 may notify the user of the determined service content. The destination of the notification may be the authentication terminal or a user terminal possessed (e.g., carried) by the user. Further, when the determined service content is permission to enter (permission to use) an area the admission to which is restricted, the processing unit 14 may output an instruction to lift the restriction on the admission to an entrance terminal or the like in the area. Further, when the determined service content is information about a privilege (hereinafter also referred to as privilege information) that will be provided to the user, the processing unit 14 may add the privilege information to the management information of the user. Alternatively, when the determined service content is a purchasing price, the processing unit 14 may apply a determined discount rate or a determined discount amount to the amount of the purchase and then carry out the payment.

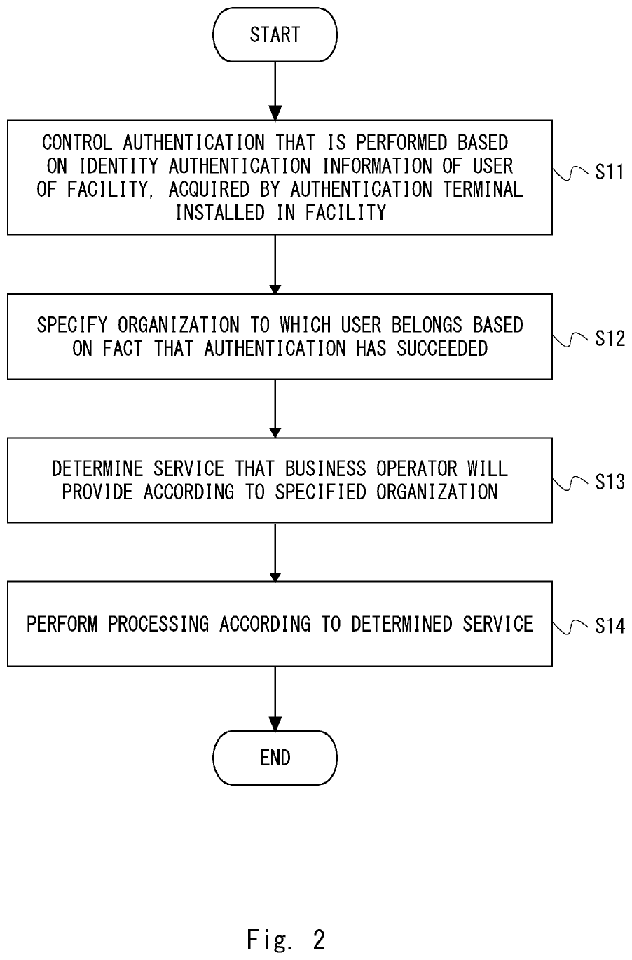

FIG. 2 is a flowchart showing a flow of a service processing method according to the first example embodiment. Firstly, the authentication control unit 11 refers to the above-described database and controls authentication that is performed based on identity authentication information of a user of a facility, acquired by an authentication terminal installed in the facility (S11). Next, the specifying unit 12 specifies an organization to which the user belongs based on the fact that the authentication has succeeded (S12). Then, the determination unit 13 determines a service that a business operator will provide according to the specified organization (S13). After that, the processing unit 14 performs processing according to the determined service (S14). Note that when the authentication in the step S11 has failed, no service is provided to the user (no determination is made and no processing is preformed).

As described above, in this example embodiment, in addition to membership information that is originally managed by the business operator who provides predetermined services at predetermined facilities, information about affiliated members managed in the partner organization of the business operator is also used. In this way, the service processing apparatus 1 can determine an appropriate service for an affiliated member according to the contract between the business operator and the partner organization, and perform processing according to the determination. Therefore, it is possible to enable a business operator who provides services to provide an appropriate service to an affiliated member or the like of a partner organization while facilitating management of membership information of affiliated members or the like of the partner organization.

Note that the service processing apparatus 1 includes a processor, a memory, and a storage device as components/structures that are not shown in the drawing. Further, in the storage device, a computer program in which processes performed in a service processing method according to this example embodiment are implemented is stored. Further, the processor loads the computer program from the storage device onto the memory and executes the loaded computer program. In this way, the processor implements the functions of the authentication control unit 11, the specifying unit 12, the determination unit 13, and the processing unit 14.

Alternatively, each of the components of the service processing apparatus 1 may be implemented by dedicated hardware. Further, some or all of the components of each apparatus may be implemented by general-purpose or dedicated circuitry, a processor, or a combination thereof. These components or the like may be formed by a single computer chip or by a plurality of computer chips connected to each other through a bus. Some or all of the components of each apparatus may be implemented by a combination of the above-mentioned circuitry or the like and a program. Further, a CPU (Central Processing Unit), a GPU (Graphics Processing Unit), an FPGA (Field-Programmable Gate Array), a quantum processor (quantum computer control chip) or the like may be used as the processor.

Further, when some or all of the components of the service processing apparatus 1 are implemented by a plurality of information processing apparatuses, circuits, or the like, the plurality of information processing apparatuses, circuits, or the like may be disposed at one place in a concentrated manner or distributed over a plurality of places. For example, the information processing apparatus, circuit, or the like may be implemented in the form of a client-server system, a cloud computing system, or the like in which components or the like are connected to each other through a communication network. Further, the functions of the service processing apparatus 1 may be provided in the form of Saas (Software as a Service).

### Second Example Embodiment

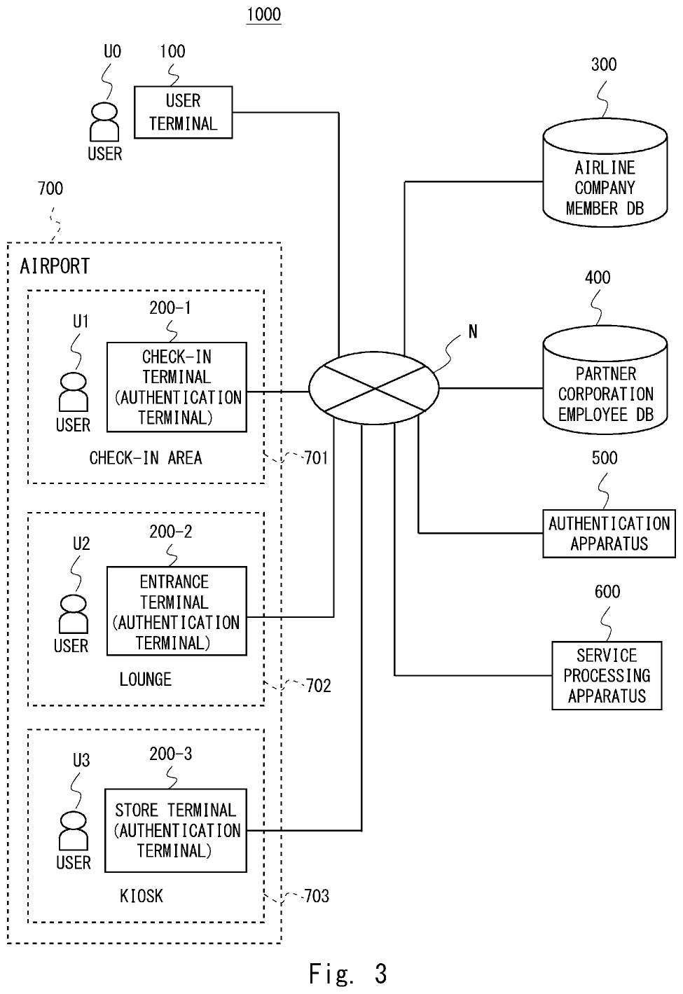

A second example embodiment is a specific example of the above-described first example embodiment. FIG. 3 is a block diagram showing an overall configuration of a service processing system 1000 according to the second example embodiment. The service processing system 1000 is an information system for processing services that are provided, by an airline company or the like, to employees and their family members of partner corporations of the airline company at an airport 700.

Note that in the following description, face authentication, which is an example of biometric authentication, is performed as identity authentication (identity verification authentication and identification specifying processing), and face feature information, which is an example of biometric information, is used as identity authentication information (identity specifying information). However, other technologies using photographed images can be used as biometric authentication and biometric information. For example, as the biometric information, data (feature values) calculated from physical features unique to individuals, such as a fingerprint, a voiceprint, a vein, a retina, an iris of a pupil, and a palm pattern, may be used. Further, other identity authentication may be used instead of the biometric authentication, and other identity authentication information may be used as the biometric information. Examples of identity authentication information include, but are not limited to, a combination of an ID and a password, details recorded in an identification card such as a My number or a driver's license (an identification number or the like, and a password), an electronic certificate, and code information. Note that the code information may be a 2D (two-dimensional) code such as a QR code (Registered Trademark).

The airport 700 is an example of the facility where various services for users are provided by an airline company or the like. The airport 700 includes, for example, areas (places) such as a check-in area 701, a lounge 702, and a kiosk 703. A check-in terminal 200-1 is installed in the check-in area 701. The check-in terminal 200-1 is an information terminal for a user of an airplane to check in (to do a boarding procedure). By the check-in terminal 200-1, a user checks in by authenticating his/her identity. The check-in terminal 200-1 may be handled by a certain airline company or may be managed by the airport 700. The lounge 702 is a rest area operated by a certain airline company or a business operator, and is an area which only those who satisfy a predetermined condition for use can use. An entrance terminal 200-2 is installed at the entrance of the lounge 702. The entrance terminal 200-2 is an information terminal that controls a gate apparatus for restricting people who can enter the lounge 702 by performing identity authentication for a person who wants to use the lounge 702. The kiosk 703 may be a store operated by a certain airline company or a business operator, or a store operated by an ordinary business operator. Further, it is assumed that the kiosk 703 provides a service such as a discount when a predetermined condition for use is satisfied. A store terminal 200-3 is installed in the kiosk 703. The store terminal 200-3 is an information terminal that performs a payment process for a commodity to be purchased by performing identity authentication for a person who wants to purchase the commodity. Note that all the check-in terminal 200-1, the entrance terminal 200-2, and the store terminal 200-3 have a common function or configuration for authenticating a user. Note that in the following description, when it is not necessary to distinguish the check-in terminal 200-1, the entrance terminal 200-2, and the store terminal 200-3 from each other, such as when a function common to them is described, they are collectively referred to simply as the “authentication terminal(s) 200”. Note that the authentication terminal 200 may be a digital signage apparatus installed in each of various places in the airport 700, or may be a display device with a camera installed in the lounge 702 or the kiosk 703.

The service processing system 1000 includes a user terminal 100, an authentication terminal 200, an airline company member DB (DataBase) 300, a partner corporation employee DB 400, an authentication apparatus 500, and a service processing apparatus 600. The user terminal 100, the authentication terminal 200, the airline company member DB 300, the partner corporation employee DB 400, the authentication apparatus 500, and the service processing apparatus 600 are connected to each other through a network N so that they can communicate with each other. The network N is a wired or wireless communication line or a communication network, and for example is the Internet. The type of the communication protocol of the network N is not limited to any particular protocols.

Here, it is assumed that users U0, U1, U2 and U3 are employees of a partner corporation or their family members. Note that an employee of a partner corporation is an example of an affiliated member of an organization. The user U0 may possess (e.g., carry) a user terminal 100 and register, for his/her ID information, a cooperative registration between the airline company and his/her own company (partner corporation) by using the user terminal 100. Note that the user U0 may be present outside the airport 700, or may stay inside the airport 700. Further, the users U1, U2 and U3 stay inside the airport 700. For example, the user U1 stays inside the check-in area 701, and the user U2 stays at the entrance of the lounge 702. Further, the user U3 stays inside the kiosk 703. Note that each of the users U1, U2 and U3 may also have a terminal equivalent to the user terminal 100.

The user terminal 100 is an information terminal operated by the user U0.

The user terminal 100 is, for example, a portable telephone terminal, a smartphone, or a tablet-type terminal. It is assumed that an application (software program) provided by the airline company is installed in the user terminal 100. By this application, for example, the user terminal 100 performs a login process by the user U0, receives an input of an employee number or the like of the partner corporation, and performs a cooperative registration process. Further, the user terminal 100 may receive notification information about a determined service content from the service processing apparatus 600 through the network N and display the received notification information on a screen.

The airline company member DB 300 is a database system operated by the airline company which is a business operator who provides services at the airport 700. The airline company member DB 300 manages members who are users of the airline company. The airline company member DB 300 may be a database server that receives an access request through the network N, performs processing for the DB, and returns the result of the processing to the entity that has issued the access request through the network N.

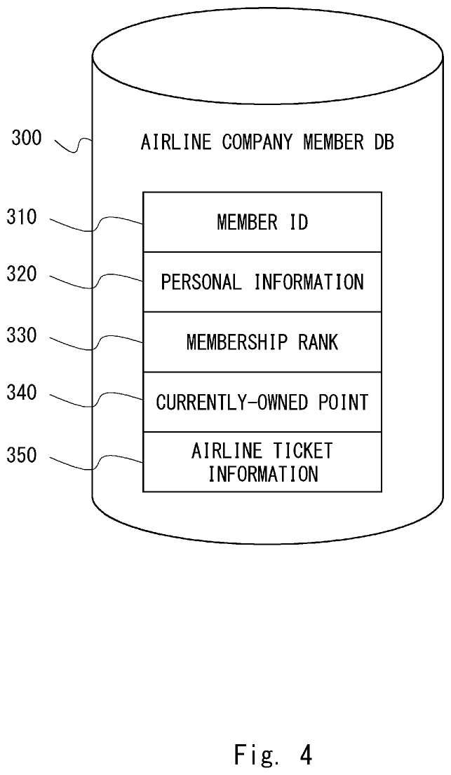

FIG. 4 shows an example of a configuration of the airline company member DB 300 according to the second example embodiment. The airline company member DB 300 manages member IDs 310, personal information 320, membership ranks 330, currently-owned points 340, and airline ticket information 350 in association with each other. The member ID 310 (i.e., each of the member IDs 310) is identification information, such as a member number, of a user of the airline company. The personal information 320 is information including a name, an address, a telephone number, payment information and the like of the user. The membership rank 330 is information corresponding to the level of a service that the member can receive. The currently-owned points 340 are an example of privilege information that can be used for the payment or the like of a usage fee for a provided service. The currently-owned points 340 may be a mileage in a so-called frequent-flyer program. The airline ticket information 350 is information about a ticket for an airplane operated by the airline company. The airline ticket information 350 may include identification information (ticket ID) of an airline ticket, a flight number, a class of a seat and the like.

The description will be continued by referring to FIG. 3 again.

The partner corporation employee DB 400 is a database system operated by a partner corporation that has a business tie-up with the airline company that operates the airline company member DB 300. The partner corporation employee DB 400 manages employee information in this partner corporation. The partner corporation employee DB 400 may be a database server that receives an access request through the network N, performs processing for the DB, and returns the result of the processing to the entity that has issued the access request through the network N.

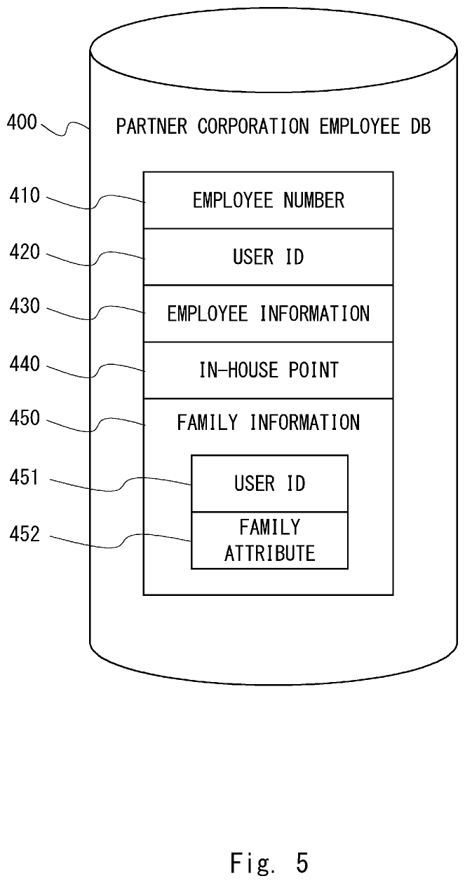

FIG. 5 shows an example of a configuration of the partner corporation employee DB 400 according to the second example embodiment. The partner corporation employee DB 400 manages employee numbers 410, user IDs 420, employee information 430, in-house points 440, and family information 450 in association with each other. The employee number 410 (i.e., each of the employee numbers) is an example of identification information of an employee of the partner corporation. The user ID 420 is other identification information of an employee and corresponds to a user ID associated with face feature information managed in the authentication apparatus 500 (which will be described later). Note that at least one of the employee number 410, the user ID 420, and the face feature information is an example of the identity authentication information. The employee information 430 is an example of affiliation information of the organization to which the affiliated member belongs. The employee information 430 includes personal information of an employee and his/her position or the like in the partner corporation. The employee information 430 includes, for example, a name, an address, a telephone number, payment information and the like of the employee. Therefore, in the partner corporation employee DB 400, affiliation information (employee information 430) of employees and identity authentication information (such as employee numbers 410 or user IDs 420) of the employees are registered in association with each other. Note that the employee information 430 may include address information (such as a terminal ID, an account of a dedicated application, and an email address) of a user terminal possessed by the user who is an employee.

The in-house points 440 are an example of information about a privilege in the organization that is given to the employee by the partner corporation. The in-house points 440 are, typically, privilege information that can be used to pay for various welfare services in the partner corporation. The in-house points 440 may also be referred to as, for example, welfare points. Note that the in-house points 440 according to this example embodiment can be used to pay a usage fee for a service provided by the airline company or to pay for a commodity sold by the airline company. Therefore, in the partner corporation employee DB 400, in-organization privilege information (in-house points 440) given in the partner corporation is registered in association with identity authentication information (such as an employee number 410 or a user ID 420) of the employee.

The family information 450 is information about family members of the employee. In the family information 450, a user ID 451 and a family attribute(s) 452 are associated with each other. The user ID 451 is identification information of a family member and corresponds to a user ID associated with face feature information managed in the authentication apparatus 500 (which will be described later). The family attribute 452 is information indicating a relationship with the employee. For example, the family attribute 452 is a relationship or the like with the employee. Therefore, in the partner corporation employee DB 400, identity authentication information (user IDs 451) of family members of employees and family attributes 452 indicating the family members of the employees are registered in association with each other. Based on the above-described matters, the partner corporation employee DB 400 can be considered to be an example of a database in which identity authentication information of affiliated members of an organization, which is a partner of a business operator who provides predetermined services in predetermined facilities, are registered.

The description will be continued by referring to FIG. 3 again.

Note that there may be a plurality of predetermined business operators such as airline companies that provide services to users in the airport 700. That is, two or more different airline company member DBs 300 may be connected to the network N. Further, in the case where there are a plurality of partner corporations of a certain business operator such as an airline company, there may be one partner corporation employee DB 400 for each of the corporations. That is, two or more different partner corporation employee DBs 400 may be connected to the network N. In other words, a specific business operator may have partnerships with a plurality of different partner corporations. Further, a specific business operator may have individual partnerships with a plurality of different airline companies.

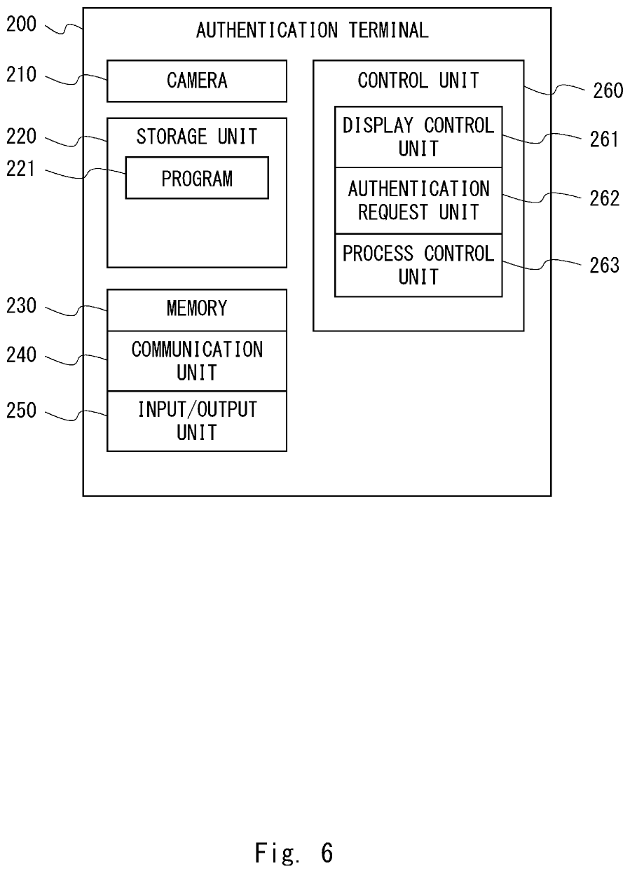

The authentication terminal 200 is an information terminal installed in a predetermined place in the airport 700. FIG. 6 is a block diagram showing a configuration of the authentication terminal 200 according to the second example embodiment. The authentication terminal 200 includes a camera 210, a storage unit 220, a memory 230, a communication unit 240, an input/output unit 250, and a control unit 260. The camera 210 is a photographing apparatus that performs photographing according to the control by the control unit 260. The storage unit 220 is an example of a storage device such as a hard disk drive or a flash memory. The storage unit 220 stores a program 221. The program 221 is a computer program in which processes including an authentication request process for starting a service providing process (which will be described later) are implemented. For example, the program 221 includes a client application corresponding to the service processing apparatus 600.

The memory 230 is a volatile storage device such as a RAM (Random Access Memory) and is a storage area for temporarily holding information when the control unit 260 is operating. The communication unit 240 is a communication interface with the network N. The input/output unit 250 includes a display device (display unit) such as a screen and an input device. The input/output unit 250 is, for example, a touch panel. The control unit 260 is a processor that controls hardware of the authentication terminal 200. The control unit 260 loads the program 221 from the storage unit 220 onto the memory 230 and executes the loaded program 221. In this way, the control unit 260 implements the functions of a display control unit 261, an authentication request unit 262, and a process control unit 263.

The display control unit 261 makes (e.g., instructs) the input/output unit 250 display a screen image generated by executing the program 221. When the authentication terminal 200 is the check-in terminal 200-1, the display control unit 261 displays a message for inducing a user or the like to photograph his/her face for face authentication, an explanation about a check-in, a menu, and the like. When the authentication terminal 200 is the entrance terminal 200-2, the display control unit 261 displays a message or the like for inducing a user or the like to photograph his/her face for the admission checking to the lounge 702. When the authentication terminal 200 is the store terminal 200-3, the display control unit 261 displays a message or the like about the settlement of commodities that user intends to purchase in the kiosk 703. Further, the display control unit 261 may make (e.g., instruct) the input/output unit 250 display the result of the authentication in response to an authentication request by the authentication request unit 262 (which will be described later). Further, the display control unit 261 makes (e.g., instructs) the input/output unit 250 display notification information sent from the service processing apparatus 600.

The authentication request unit 262 extracts a face area of a person detected from an image taken by the camera 210 as a face image, and transmits an authentication request including the face image, terminal position information, and time information to the service processing apparatus 600. Note that the authentication request does not necessarily have to include the time information. Note that the authentication request unit 262 may transmit the face authentication request including the face image to the authentication apparatus 500 and receive a face authentication result from the authentication apparatus 500. Then, when the face authentication result indicates success, the authentication request unit 262 may extract a user ID included in the face authentication result and transmit information including the extracted user ID, terminal position information, and time information to the service processing apparatus 600.

Note that the authentication request unit 262 may acquire, in addition to or instead of the face image, biometric information or other identity authentication information from the user and include (i.e., incorporate) the acquired identity authentication information in the authentication request. For example, the authentication request unit 262 may acquire identity authentication information by reading code information printed on an airline ticket or code information of an airline ticket displayed on the user terminal 100. Alternatively, the authentication request unit 262 may read identity authentication information from a magnetic code of a membership card of an airline ticket or from an IC (Integrated Circuit) chip embedded in a membership card.

The process control unit 263 controls processing unique to each authentication terminal. For example, when the authentication terminal 200 is the check-in terminal 200-1, the process control unit 263 performs a predetermined check-in process according to the success of the identity authentication of the user. Note that the process control unit 263 may communicate with the airline company member DB 300 and other apparatuses related to the airport 700 as required. When the authentication terminal 200 is the entrance terminal 200-2, the process control unit 263 performs control so as to unlock a gate apparatus at the entrance of the lounge 702 when the user has succeeded the identity authentication and satisfies a condition for the use of the lounge 702. The condition for the use of the lounge 702 may include a condition that the membership rank is equal to or higher than a certain level or a condition that the user is an employee of a partner corporation of the airline company or his/her family member. When the authentication terminal 200 is the store terminal 200-3, the process control unit 263 carries out settlement for commodities to be purchased and a payment process therefor.

The description will be continued by referring to FIG. 3 again.

The authentication apparatus 500 is an information processing apparatus that manages face feature information of users and performs face authentication. Further, in response to an externally-received face authentication request, the authentication apparatus 500 compares a face image or face feature information included in the request with face feature information of each of the users, and returns the result of the comparison (authentication result) to the entity that has issued the request.

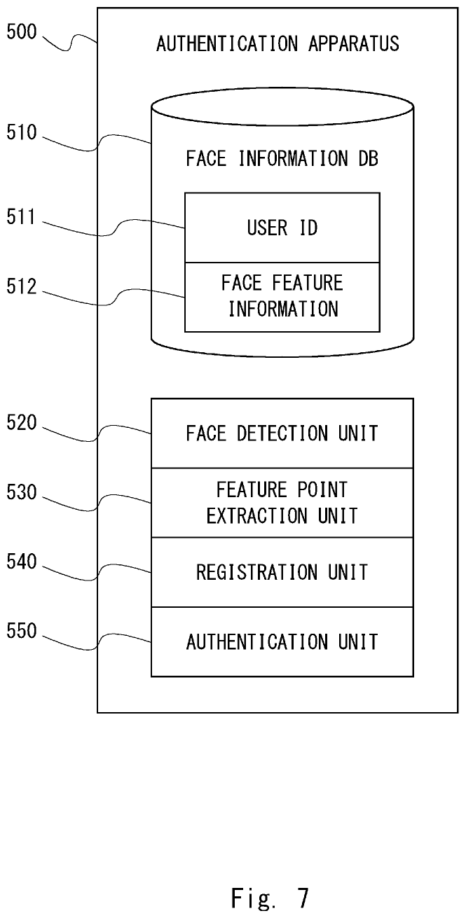

FIG. 7 is a block diagram showing a configuration of the authentication apparatus 500 according to the second example embodiment. The authentication apparatus 500 includes a face information DB 510, a face detection unit 520, a feature point extraction unit 530, a registration unit 540, and an authentication unit 550. In the face information DB 510, user IDs 511 and face feature information 512 of the user IDs are stored in association with each other. The face feature information 512 is a set of feature points extracted from a face image. Note that the authentication apparatus 500 may delete the face feature information 512 stored in the face feature DB 510 in response to a request from a user or the like corresponding to the face feature information 512. Alternatively, the authentication apparatus 500 may delete the face feature information 512 when a certain period has elapsed after the registration thereof.

The face detection unit 520 detects a face area included in a registration image for registering face information and outputs the detected face area to the feature point extraction unit 530. The feature point extraction unit 530 extracts feature points from the face area detected by the face detection unit 520 and outputs face feature information to the registration unit 540. Further, the feature point extraction unit 530 extracts feature points included in a face image received from the service processing apparatus 600 or the like and outputs face feature information to the authentication unit 550.

The registration unit 540 issues a new user ID 511 when face feature information is registered. The registration unit 540 associates the issued user ID 511 with the face feature information 512 extracted from the registration image and registers them in the face information DB 510. The authentication unit 550 performs face authentication by using the face feature information 512. Specifically, the authentication unit 550 compares the face feature information extracted from the face image with face feature information 512 recorded in the face information DB 510. When the authentication unit 550 has succeeded in the comparison, it specifies the user ID 511 associated with the compared face feature information 512. The authentication unit 550 returns information as to whether the face feature information has matched or not to the entity that has issued the request as a face authentication result. Whether the face feature information has matched or not corresponds to whether the authentication has succeeded or not. Note that it is assumed that the fact that the face feature information has matched (there is a match) means the degree of matching is equal to or higher than a threshold. Further, it is assumed that when the face authentication has succeeded, the face authentication result includes the specified user ID.

The description will be continued by referring to FIG. 3 again.

The service processing apparatus 600 is an information processing apparatus that performs an employee information registration process, a cooperative registration process, a service providing process, and the like. The service processing apparatus 600 is an example of the above-described service processing apparatus 1. The service processing apparatus 600 may be configured in a redundant manner by using a plurality of servers, and each functional block may be implemented by a plurality of computers.

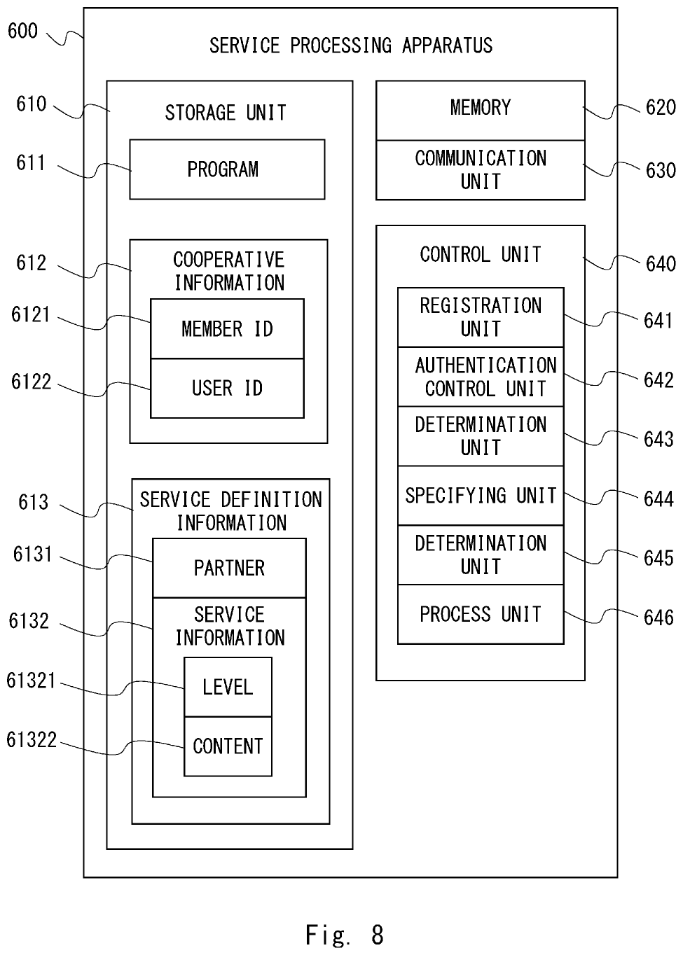

FIG. 8 is a block diagram showing a configuration of the service processing apparatus 600 according to the second example embodiment. The service processing apparatus 600 includes a storage unit 610, a memory 620, a communication unit 630, and a control unit 640. The storage unit 610 is an example of a storage device such as a hard disk drive or a flash memory. The storage unit 610 stores a program 611, cooperative information 612, and service definition information 613. The program 611 is a computer program in which processes including an employee information registration process, a cooperative registration process, and a service providing process according to the second example embodiment are implemented.

The cooperative information 612 is information for implementing a cooperation between a business operator such as airline company and its partner corporation. Note that the cooperative information 612 indicates information defining association between the airline company member DB 300 and the partner corporation employee DB 400 (and the face information DB 510). Note that the method for implementing a cooperation is not limited to this example. Specifically, the cooperative information 612 is information in which member IDs 6121 are associated with user IDs 6122. The member IDs 6121 are information corresponding to the member IDs 310 recorded in the above-described airline company member DB 300. The user IDs 6122 are information corresponding to the user IDs 511 recorded in the above-described face information DB 510. Note that for the cooperative information 612, employee numbers 410 recorded in the above-described partner corporation employee DB 400 may be used instead of the user IDs 6122. Alternatively, other employee identification information (employee IDs) may be used instead of the employee numbers 410. That is, the cooperative information 612 may be information in which member IDs 6121 are associated with employee numbers 410 or other employee identification information (employee IDs).

The service definition information 613 is definition information related to services that a business operator such as an airline company provides in the airport 700. In the service definition information 613, partners 6131 are associated with service information 6132. The partners 6131 are information specifying partner corporations of a specific business operator. For example, the partners 6131 may be identification information of such corporations. Further, the partner corporation employee DB 400 can be uniquely specified by the partner 6131. That is, the partners 6131 are information corresponding to the partner corporation employee DB 400. In the service information 6132, levels 61321 are associated with contents 61322. The levels 61321 are information indicating service levels. The level 61321 may be, for example, information indicating the grade of a seat of an airplane, a discount rate or a discount amount of a payment amount, or a level of privilege information or the like to be given. The content 61322 is information indicating the content of a service to be provided. Examples of contents 61322 include, but are not limited to, privilege information such as points, permission to use a lounge, a discount rate or a discount amount of a purchasing price at a kiosk, and upgrading of a seat.

The memory 620 is a volatile storage device such as a RAM and is a storage area for temporarily holding information when the control unit 640 is operating. The communication unit 630 is a communication interface with the network N.

The control unit 640 is a processor or a control apparatus that controls each component/structure of the service processing apparatus 600. The control unit 640 loads the program 611 from the storage unit 610 onto the memory 620 and executes the loaded program 611. In this way, the control unit 640 implements the functions of a registration unit 641, an authentication control unit 642, a judgement unit 643, a specifying unit 644, a determination unit 645, and a processing unit 646.

The registration unit 641 performs an employee information registration process and a cooperative registration process. The registration unit 641 makes a registration in the partner corporation employee DB 400 based on a registration request including a face image and employee information of an employee of a partner corporation. In this process, the registration unit 641 transmits, for the face image included in the registration request, a face information registration request to the authentication apparatus 500, and acquires a user ID as a registration result. The registration unit 641 registers, in the partner corporation employee DB 400, the issued employee number, the acquired user ID, and the employee information included in the registration request in association with each other.

Further, the registration unit 641 receives a pair of a member ID and an employee number, and acquires a user ID 420 corresponding to the received employee number 410 from the partner corporation employee DB 400. Then, the registration unit 641 registers, in the storage unit 610, the cooperative information 612 in which the received member ID 6121 is associated with the acquired user ID 6122.

The authentication control unit 642 is an example of the above-described authentication control unit 11. The authentication control unit 642 controls face authentication, which is an example of biometric authentication, as identity authentication. However, the authentication control unit 642 may control other biometric authentication or other identity authentication. The authentication control unit 642 controls face authentication for the face image included in the authentication request. That is, the authentication control unit 642 controls authentication using identity authentication information for registration and authentication. Specifically, the authentication control unit 642 transmits a face authentication request including a face image to the authentication apparatus 500 and receives a face authentication result from the authentication apparatus 500. Note that the authentication control unit 642 may detect a face area of the user from the face image and include (i.e., incorporate) the image in the face area in the face authentication request. Alternatively, the authentication control unit 642 may extract face feature information from the face area and include (i.e., incorporate) face feature information in the face authentication request.

The judgement unit 643 determines whether or not the face authentication has succeeded based on the face authentication result by the authentication control unit 642. Further, the judgement unit 643 transmits a member verification request including a member ID to the airline company member DB 300 and receives a verification result. Then, the judgement unit 643 determines whether or not a member has already been registered based on the verification result. Further, the judgement unit 643 transmits an employee verification request including an employee number or a user ID to the partner corporation employee DB 400 and receives a verification result. Then, the judgement unit 643 determines whether the user is an employee or his/her family member based on the verification result. For example, the judgement unit 643 determines that the user is a family member of an employee of a partner corporation when a family attribute is associated with the identity authentication information (user ID) for which the face authentication has succeeded.

The specifying unit 644 is an example of the above-described specifying unit 12. When the specifying unit 644 determines that the judgement unit 643 has succeeded in the face authentication, it specifies, from the cooperative information 612, a member ID 6121 associated with the user ID 6122 included in the face authentication result. Further, the specifying unit 644 specifies, by referring to the service definition information 613, a partner 6131 based on the result of the verification by the judgement unit 643, which has been performed in response to the employee verification request. Further, when the judgement unit 643 has determined that the verification result indicates a family member of an employee of a partner corporation, the specifying unit 644 specifies the partner corporation to which the employee corresponding to the family attribute of the family member belongs.

The determination unit 645 is an example of the above-described determination unit 13. The determination unit 645 determines a service according to the partner corporation specified by the specifying unit 644. Specifically, the determination unit 645 determines, from the service definition information 613, service information 6132 associated with the specified partner 6131 as a service to be provided. Further, when the user, who has succeeded in the authentication, is an employee of a partner corporation, the determination unit 645 may determine a service according to affiliation information (employee information 430). For example, the determination unit 645 may select a level 61321 according to the position or the like in the partner corporation, and determine service information 6132 including the selected level.

Further, the determination unit 645 may determine a service while taking in-house points 440 associated with the user, who has succeeded in the authentication, into consideration. For example, the determination unit 645 may determine, as a service, that the purchasing price can be reduced by an amount equivalent to some of the in-house points 440 (i.e., determine that in-house points can be used). When doing so, the determination unit 645 may calculate the payment amount by reducing an amount equivalent to some of the in-house points 440 from the purchasing price. Further, the determination unit 645 may calculate the payment amount by reducing, of the in-house points 440, an amount equivalent to points designated by the user. Further, the determination unit 645 may also determine a higher service higher than the current service level which the user can use by using the in-house points 440.

Further, the determination unit 645 may determine a service according to whether the user, who has succeeded in the authentication, is an employee of a partner corporation or a family member of an employee. That is, when the user, who has succeeded in the authentication, is a family member of an employee of a partner corporation (when an organization to which the affiliated member indicated by the family attribute belongs is specified), the determination unit 645 may determine a service at a service level different from that for an employee. For example, when the user, who has succeeded in the authentication, is an employee of a partner corporation, the determination unit 645 may determine, as a service, a higher discount rate or a larger discount amount than when the user is a family member of an employee. Further, when the user, who has succeeded in the authentication, is either an employee of a partner corporation or a family member of an employee, the determination unit 645 may determine a service according to the employee information (such as a department to which the employee belongs, a position, and years of service) of the employee. For example, the determination unit 645 may increase a service level compared to those for other employees or determine a higher discount rate or a larger discount amount when: the position is a certain position or higher; the employee has worked for the corporation for a predetermined years or longer; or the employee belongs to a specific department (e.g., a sales department) of which the contract fee is equal to or higher than a certain amount. Alternatively, the determination unit 645 may increase a service level compared to those for other employees or determine a higher discount rate or a larger discount amount in such a manner that the higher the position is, the longer the length of the service is, or the higher the contract fee of the department is, the more the service level is increased, or the more the discount rate or the discount amount is increased.

Further, the determination unit 645 may determine a service together with privilege information related to a usage fee. For example, the determination unit 645 may give points of the airline company or in-house points of the partner corporation as privilege information. Further, the determination unit 645 may determine, when the user, who has succeeded in the authentication, is either an employee of a partner corporation or a family member of an employee, privilege information so that the privilege is changed according to the employee information of the employee.

Further, when authentication based on identity authentication information acquired by an authentication terminal installed in a first place of the airport 700 has succeeded, the determination unit 645 may determine a service that the business operator will provide in a second place of the airport 700. For example, when a user has succeeded in the authentication in the check-in terminal 200-1 installed in the check-in area 701, the determination unit 645 may determine a service that will be provided in the lounge 702 (e.g., information indicating that a service can be used in the lounge 702).

The processing unit 646 is an example of the processing unit 14. The processing unit 646 performs processing according to the service determined by the determination unit 645. In particular, the processing unit 646 notifies the user (who has succeeded in the authentication) of notification information about the determined service. Specifically, the processing unit 646 transmits the notification information to the authentication terminal, with which the authentication has been performed. Alternatively, the processing unit 646 may transmit the notification information to a user terminal possessed (e.g., carried) by the user, who has succeeded in the authentication.

Further, when a service that will be provided in a second place different from a first place in which the authentication terminal with which the authentication has succeeded is installed is determined, the processing unit 646 notifies the authentication terminal installed in the first place of notification information indicating that the determined service can be used in the second place. When doing so, the processing unit 646 preferably notifies the authentication terminal of notification information further including route information from the first place to the second place.

Further, the processing unit 646 may preferably notify the user that he/she can use in-house points for the payment of the usage fee for the determined service. Note that the usage fee for the service includes the usage fee for the payment service when the user purchases a commodity. That is, the processing unit 646 may provide a service by which the user can carry out payment by using in-house points and thereby reducing the purchasing price of a commodity in the kiosk 703. Further, the processing unit 646 may notify the user that if he/she uses in-house points, he/she can use the determined higher service.

The processing unit 646 may externally output information based on the record of use of services provided to the user. For example, the processing unit 646 may provide, for example, a history in regard to the recode of use of services and/or a result of an analysis of the trend of use to the business operator or other marketing business operators. The processing unit 646 may analyze the record of use of services for each partner corporation, or analyze it based on the attributes (such as a gender, an age, a work place, and a department) of the user, the service type, and the like.

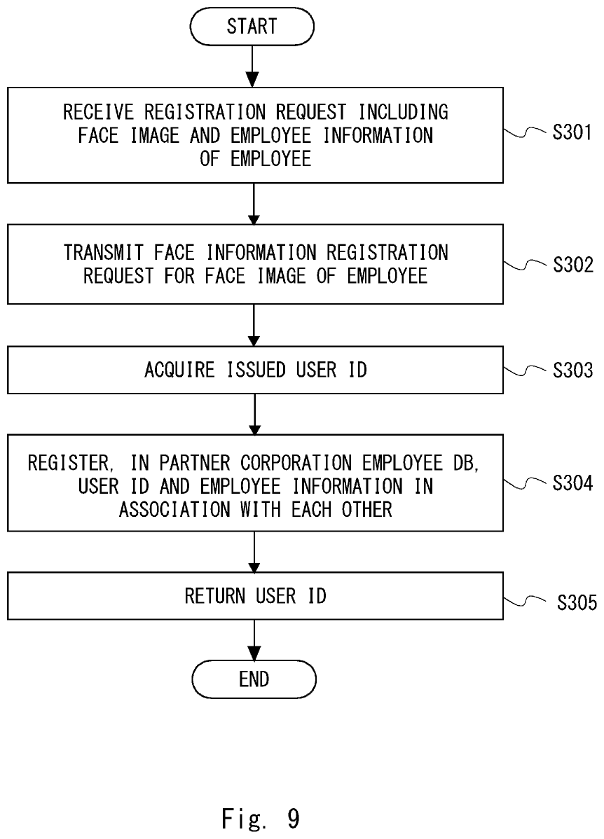

FIG. 9 is a flowchart showing a flow of an employee information registration process according to the second example embodiment. An example in which a person in charge in a partner corporation registers employee information of one person (one family) by using an in-house computer (a registration terminal (not shown)) will be described hereinafter. However, the process for registering employee information may be performed though a batch process. Alternatively, a request for registering employee information may be transmitted from the user terminal 100. Note that it is assumed that an employee number has already been issued, but it may be issued during the employee information registration process.

Firstly, the registration terminal receives an input of a face image and employee information of an employee to be registered from the person in charge, and transmits a registration request including the face image and the employee information to the service processing apparatus 600 through the network N. Note that an employee number may be included in the registration request. In response to this, the registration unit 641 of the service processing apparatus 600 receives the registration request including the face image and the employee information from the registration terminal through the network N (S301).

Next, the registration unit 641 acquires the face image of the employee from the received registration request, and transmits a face information registration request including the face image to the authentication apparatus 500 through the network N (S302). In response to this, the authentication apparatus 500 performs a face information registration process.

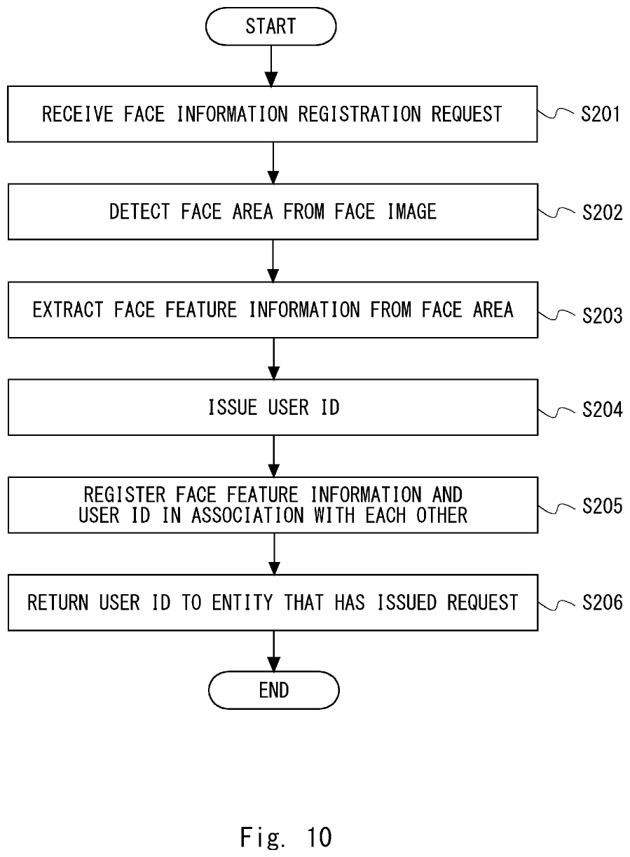

FIG. 10 is a flowchart showing a flow of a face information registration process performed by the authentication apparatus 500 according to the second example embodiment. Firstly, the authentication apparatus 500 receives a face information registration request (S201). For example, the authentication apparatus 500 receives a face information registration request from the service processing apparatus 600 through the network N. Next, the face detection unit 520 detects a face area from a face image included in the face information registration request (S202). Then, the feature point extraction unit 530 extracts feature points (face feature information) from the face area detected in the step S202 (S203). Then, the registration unit 540 issues a user ID 511 (S204). Then, the registration unit 540 associates the extracted face feature information 512 with the issued user ID 511 and registers them in the face information DB 510 (S205). After that, the registration unit 540 returns the issued user ID 511 to the entity that has issued the request (e.g., the service processing apparatus 600) (S206). Note that the authentication apparatus 500 may perform the face information registration process in response to a face information registration request received from an arbitrary information registration terminal. For example, the information registration terminal is an information processing apparatus such as a personal computer, a smartphone, or a tablet-type terminal. Further, the information registration terminal may be the user terminal 100.

The description will be continued by referring to FIG. 9 again. The registration unit 641 of the service processing apparatus 600 acquires the issued user ID from the authentication apparatus 500 through the network N (S303). Then, the registration unit 641 acquires an employee number from the received registration request. Alternatively, the registration unit 641 may specify an employee number 410 registered in the partner corporation employee DB 400 based on the employee information 430 included in the registration request. Note that when an employee number has not been issued, the registration unit 641 issues a new employee number.

Then, the registration unit 641 registers, in the partner corporation employee DB 400, the acquired employee number 410, the acquired user ID 420, and the employee information 430 included in the registration request in association with each other (S304). Note that when the employee information is newly registered in this process, a predetermined value, e.g., 0 point, is set as in-house point 440.

After that, the registration unit 641 returns the acquired user ID to the registration terminal through the network N (S305).

Note that the registration unit 641 does not necessarily have to perform the employee information registration process. In such a case, for example, the registration terminal preferably transmits a face information registration request to the authentication apparatus 500 without the service processing apparatus 600 intervening therebetween, acquires a user ID, and then registers it in the partner corporation employee DB 400 as in the step S304.

Note that it is assumed that family information of the employee is registered together with the employee information or after the registration of the employee information. For example, the registration terminal may receive an input of an employee number, and face images and family attributes of family members of the employee, and transmit a registration request including them. In such a case, the service processing apparatus 600 processes the face images included in the registration request as in the steps S302 and S303. Then, the service processing apparatus 600 may register, in the partner corporation employee DB 400, family information 450 including the user ID 451 and the family attribute 452 in association with the employee number 410 included in the registration request. Note that the family information of the employee, especially face images of his/her family members, do not necessarily have to be registered.

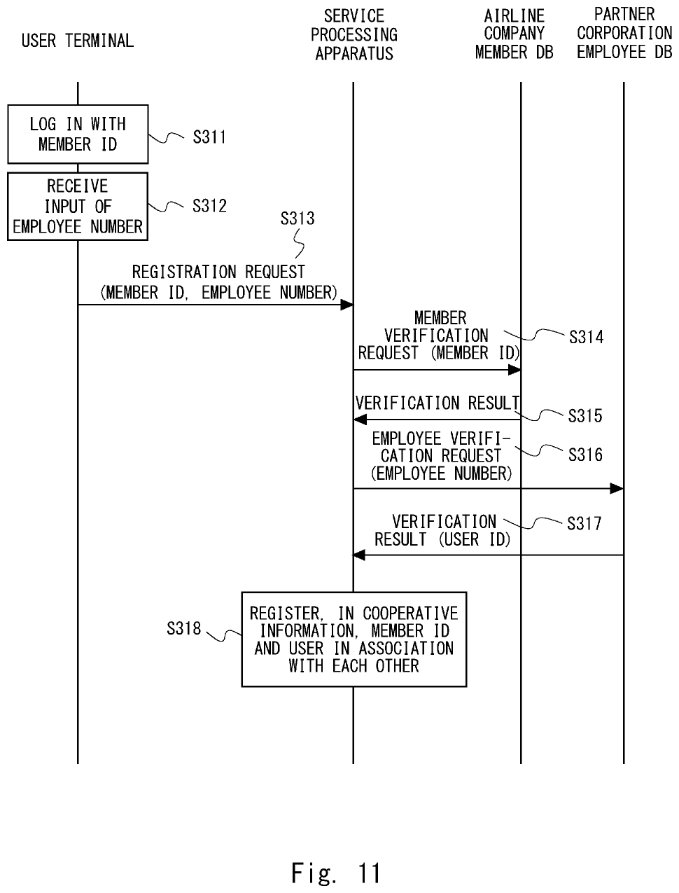

FIG. 11 is a sequence diagram showing a flow of a cooperative registration process according to the second example embodiment. In this example, it is assumed that a user U0 is an employee of a partner corporation, and the user U0 himself/herself and his/her family members have already been registered in the partner corporation employee DB 400 by the above-described process for registering employee information. Further, it is assumed that the user U0 knows at least his own employee number. Further, it is assumed that the user U0 has already being registered as a member in an airline company member DB 300 of a predetermined airline company, and he/she knows his/her own member ID. Then, an example in which the user U0 makes, for himself/herself, a cooperative registration between the airline company and a company to which he/she belongs (i.e., a partner corporation) by using a user terminal 100 will be described. However, the cooperative registration process may be performed in response to a request from a computer (a registration terminal (not shown)) of a partner corporation, an airline company, or any other system-related company. Further, the cooperative registration process may be performed through a batch process for a large number of employees and family members in response to a request from a registration terminal. In this case, the airline company and the partner corporation may perform a DB cooperative process in a collective manner by, for example, comparing their personal information with each other.

Firstly, the user terminal 100 starts an application provided by the airline company in response to an operation performed by the user U0, and performs a login process by using a member ID (S311). Next, the user terminal 100 receives an input of an employee number from the user U0 (S312). Then, the user terminal 100 transmits a registration request including the logged-in member ID and the input employee number to the service processing apparatus 600 through the network N (S313). In response to this, the registration unit 641 of the service processing apparatus 600 receives the registration request including the pair of the member ID and the employee number from the user terminal 100 through the network N.

Then, the judgement unit 643 of the service processing apparatus 600 transmits a member verification request including the member ID included in the registration request to the airline company member DB 300 through the network N (S314), and receives a verification result (S315). Then, the judgement unit 643 determines whether or not the member has already been registered based on the verification result. In this example, it is assumed that it is determined that the user U0 has already been registered as a member of the airline company (in the airline company member DB 300).

Further, the judgement unit 643 transmits an employee verification request including the employee number included in the registration request to the partner corporation employee DB 400 (S316), and receives a verification result (S317). When there is the employee number in the partner corporation employee DB 400, the verification result includes a user ID 420 associated with the employee number 410. Then, the judgement unit 643 determines whether or not the user is an employee based on the verification result. In this example, it is assumed that it is determined that the user U0 is an employee of a partner corporation. Note that the steps S314 and S315 and the steps S316 and S317 may be performed independently of each other or performed in parallel with each other.

After that, the registration unit 641 registers cooperative information 612 in which the received member ID 6121 is associated with the acquired user ID 6122 in the storage unit 610 (S318).

Note that in the step S312, the user terminal 100 may receive an input of a user ID instead of the employee number. For example, it is applicable when the user U0 is a family member of an employee, or even when the user U0, who is an employee, registers his/her own family members. In this case, the user terminal 100 transmits a registration request including the member ID and the user ID to the service processing apparatus 600. Then, the judgement unit 643 transmits an employee verification request including the user ID included in the registration request to the partner corporation employee DB 400, and receives a verification result. When there is the user ID in the partner corporation employee DB 400, an employee number 410 associated with this user ID 420 is included in the verification result. The rest of the processes are similar to those in FIG. 11.

Alternatively, in the step S312, the user terminal 100 may photograph the face of the user U0. Then, the user terminal 100 transmits a registration request including the member ID and the face image to the service processing apparatus 600. In this case, the authentication control unit 642 of the service processing apparatus 600 transmits a face authentication request including the face image to the authentication apparatus 500, and receives a face authentication result. When the face authentication has succeeded, a user ID is included in the face authentication result. Therefore, the judgement unit 643 transmits an employee verification request including the user ID included in the face authentication result to the partner corporation employee DB 400, and receives a verification result. The rest of the processes are similar to those in FIG. 11. For example, it is applicable when the input of an employee number or a user ID is complicated or unknown. Further, when the user U0 is a family member of an employee, no employee number has been issued and hence the input of a user ID is complicated or unknown, so that the above-described process is effective.

Further, in the step S318, the registration unit 641 may associate the member ID with the employee number and register them in the storage unit 610 as cooperative information 612.

Note that the way of realizing a cooperation between a service provider (business operator) such as an airline company and a partner corporation is not limited to the above-described example. Although it is assumed that the user U0 has already been registered as a member in the airline company member DB 300 in the above-described FIG. 11, the user U0 may not have been registered as a member. For example, an employee of a partner corporation and his/her family members may be collectively and impartially registered as members of a business operator. When doing so, among employees or the like of the partner corporation, for those who have already been registered as members of the business operator, their existing member IDs may also be used as member IDs in the above-described apparatus and the like. After that, the cooperative registration process may be performed as described above.

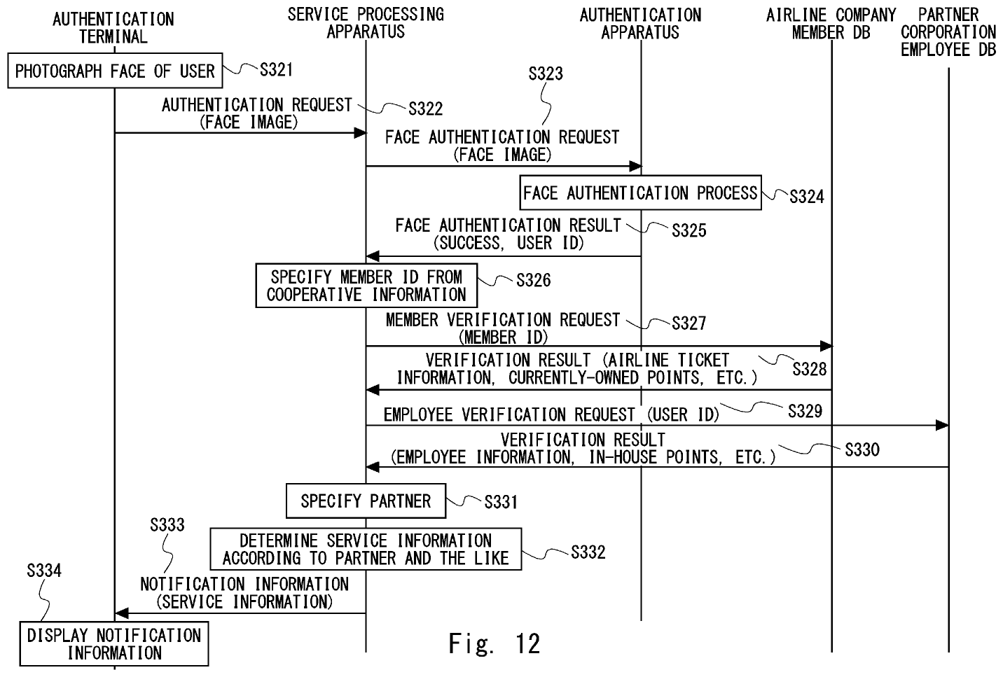

FIG. 12 is a flowchart showing a flow of a service providing process according to the second example embodiment. It is assumed that a user is staying in front of the authentication terminal 200 in the airport 700. For example, the user U1 is in front of the check-in terminal 200-1 in the check-in area 701.

In this state, the check-in terminal 200-1 photographs the face of the user U1 (S321). Then, the check-in terminal 200-1 transmits an authentication request including the photographed face image to the service processing apparatus 600 through the network N (S322). In response to this, the authentication control unit 642 of the service processing apparatus 600 receives the authentication request from the check-in terminal 200-1 through the network N. Then, the authentication control unit 642 extracts the face image from the authentication request and transmits a face authentication request including the face image to the authentication apparatus 500 through the network N (S323). In response to this, the authentication apparatus 500 performs a face authentication process (S324).

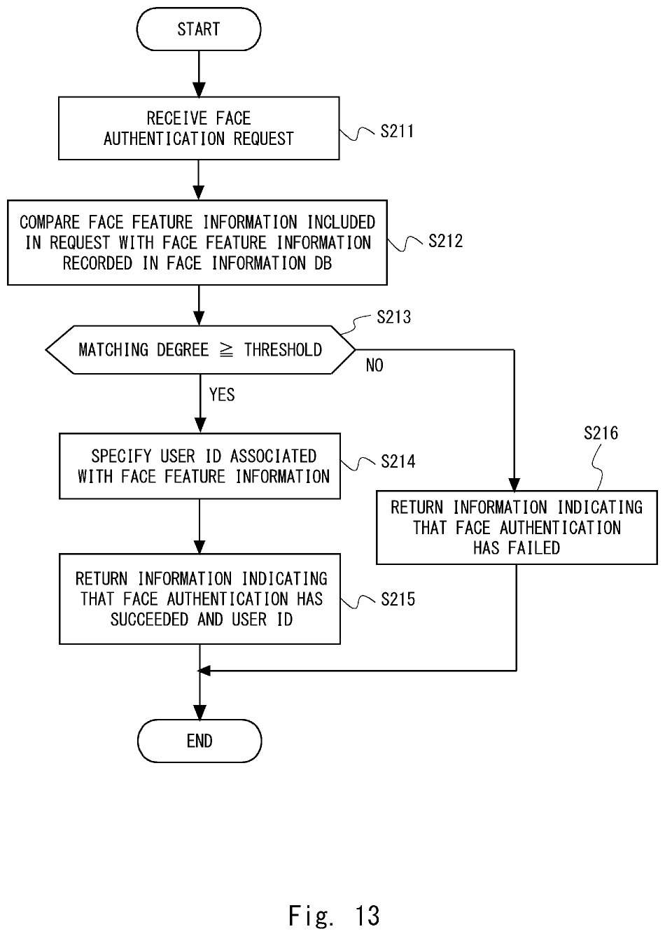

FIG. 13 is a flowchart showing a flow of a face authentication process performed by the authentication apparatus 500 according to the second example embodiment. Firstly, the authentication apparatus 500 receives a face authentication request from the service processing apparatus 600 through the network N (S211). Note that the authentication apparatus 500 may receive a face authentication request from the user terminal 100, the authentication terminal 200, or the like. Next, the authentication apparatus 500 extracts face feature information from a face image included in the face authentication request as in the above-described steps S202 and S203. Then, the authentication unit 550 of the authentication apparatus 500 compares the face feature information extracted from the face image included in the face authentication request with face feature information 512 recorded in the face information DB 510 (S212), and calculates the degree of matching. Then, the authentication unit 550 determines whether or not the degree of matching is equal to or higher than a threshold (S213). When the face feature information matches each other, that is, when the degree of matching of the face feature information is equal to or higher than the threshold, the authentication unit 550 specifies a user ID 511 associated with the face feature information 512 (S214). Then, the authentication unit 550 returns a face authentication result including information indicating that the face authentication has succeeded and the specified user ID 511 to the service processing apparatus 600 through the network N (S215). When the degree of matching is lower the threshold in the step S213, the authentication unit 550 returns a face authentication result including information indicating that the face authentication has failed to the service processing apparatus 600 through the network N (S216).

The description will be continued by referring to FIG. 12 again.

The authentication control unit 642 of the service processing apparatus 600 receives the face authentication result from the authentication apparatus 500 through the network N (S325). Here, it is assumed that the face authentication result includes information indicating that the face authentication has succeeded and the user ID. The judgement unit 643 determines whether or not the face authentication has succeeded based on the face authentication result. Note that when the face authentication result indicates that the face authentication has failed, the processing unit 646 returns information indicating that the authentication has failed (or indicating that the user or the like cannot check in) to the check-in terminal 200-1 through the network N.

Here, the description will be continued on the assumption that the face authentication has succeeded. Therefore, the specifying unit 644 specifies, from the cooperative information 612, a member ID 6121 associated with the user ID 6122 included in the face authentication result (S326).

Then, the judgement unit 643 transmits a member verification request including the specified member ID to the airline company member DB 300 through the network N (S327), and receives a verification result (S328). Here, it is assumed that the verification result includes airline ticket information 350, currently-owned points 340, a membership rank 330, and the like. Then, the judgement unit 643 determines whether or not the user has already been registered as a member based on the verification result.

Further, the judgement unit 643 transmits an employee verification request including the user ID included in the face authentication result to the partner corporation employee DB 400 (S329), and receives a verification result (S330). Here, it is assumed that the verification result includes employee information 430, in-house points 440, and the like. Note that when there are a plurality of partner corporations of the airline company, the judgement unit 643 transmits an employee verification request to each of the partner corporation employee DBs 400 corresponding to the respective corporations. Then, the judgement unit 643 determines, for each verification result in response to a request, whether or not the user is an employee of the corporation. Note that when the user U1 is a family member of an employee, the verification result includes family attribute 452. Then, the judgement unit 643 determines, based on the verification result, whether or not the user is an employee of the corporation or a family member of an employee of the company.

Note that when the user U1 is not registered as a member of the airline company or is not an employee of a partner corporation nor a family member of an employee, the processing unit 646 returns an instruction for a check-in process to the check-in terminal 200-1 through the network N. Then, the service processing apparatus 600 finishes the series of processes.

In this example, it is assumed that the user U1 has already been registered as a member of the airline company (in the airline company member DB 300) and that the user U1 is an employee of a partner corporation. Therefore, the specifying unit 644 specifies a partner 6131 by referring to the service definition information 613. Specifically, the specifying unit 644 specifies a partner corresponding to the partner corporation employee DB 400 which is determined to correspond to an employee of the corporation based on the verification result.

Then, the determination unit 645 determines service information corresponding to the specified partner corporation (S332). In this process, as described above, the determination unit 645 may determine service information while taking the specified partner corporation, and employee information, a family attribute, in-house points and the like of the user, who has succeeded in the authentication, into consideration. Note that a specific example of service information to be determined will be described later.

After that, the processing unit 646 generates notification information including the determined service information and transmits the generated notification information to the check-in terminal 200-1 through the network N (S333). Specifically, the processing unit 646 may generate notification information including at least a content 61322 of the determined service information 6132. Further, the processing unit 646 may generate notification information including check-in information, such as airline ticket information, related to the check-in.

In response to this, the check-in terminal 200-1 receives the notification information from the service processing apparatus 600 through the network N and displays the received notification information on a screen (S334).

For example, when points are given according to the check-in process, the determination unit 645 may typically determine, as the service information, earned points which are obtained by adding additional points determined according to the partner corporation to the points to be given. In this process, the determination unit 645 may include (i.e., incorporate) a breakdown (i.e., details) of the given points in the service information. Then, the processing unit 646 generates notification information including the check-in information, earned points, and the breakdown and the like of the points, and transmits the generated notification information to the check-in terminal 200-1.

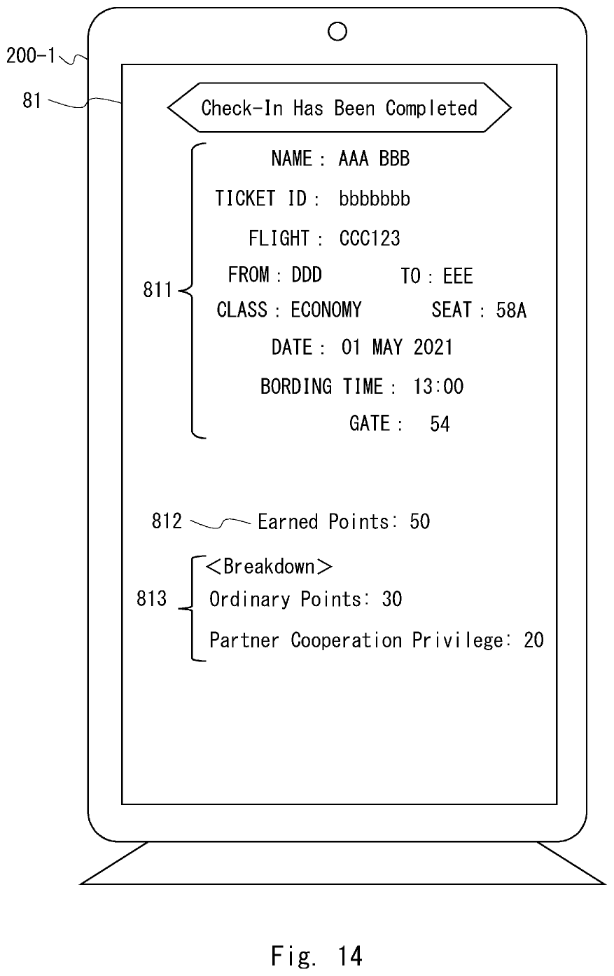

In response to this, the check-in terminal 200-1 displays a notification information display screen image 81. FIG. 14 shows an example of the notification information display screen image 81 according to the second example embodiment. The notification information display screen image 81 includes check-in information 811, earned points 812, and a breakdown (i.e., details) 813 of the points. The check-in information 811 is an example of information about check-in by a user who has checked in by using the check-in terminal 200-1. The check-in information 811 includes, for example, but is not limited to, the name of the user who has completed a boarding procedure for an airplane, a ticket ID of an airline ticket, a flight number, a departure place, an arrival place, the class of a seat, a seat number, a departure date, a boarding deadline time, and a boarding gate. The earned points 812 indicate the number of points that has been given according to the check-in process. Here, it is assumed that 50 points have been given. The point breakdown 813 indicates the breakdown (i.e., details) of the earned points 812. In this example, it is shown that ordinary points (points given even when the user is not an employee of a partner corporation or the like) are 30 points, and points given as a privilege because the user is an employee of a partner corporation or the like are 20 points. Note that the partner corporation privilege may be determined (given) differently according to the partner corporation, whether the user is an employee or his/her family member, the check-in process, the use of a lounge, the purchase of commodities, and the like.

Other examples of services to be provided include to guide a user or the like to a higher service or the like by using in-house points in the check-in process. In such a case, the determination unit 645 determined whether or not the current class of the seat in the checked-in airline ticket information can be upgraded to a higher one by using in-house points of the user, who has succeeded in the authentication. Then, when it is possible to upgrade the class, the determination unit 645 determines, as the service information, the number of in-house points required for the upgrading and a higher service including classes to which the current class can be upgraded. Then, the processing unit 646 generates notification information including the check-in information, the current in-house points, the service information, and guide information to the higher service or the like, and transmits the generated notification information to the check-in terminal 200-1.

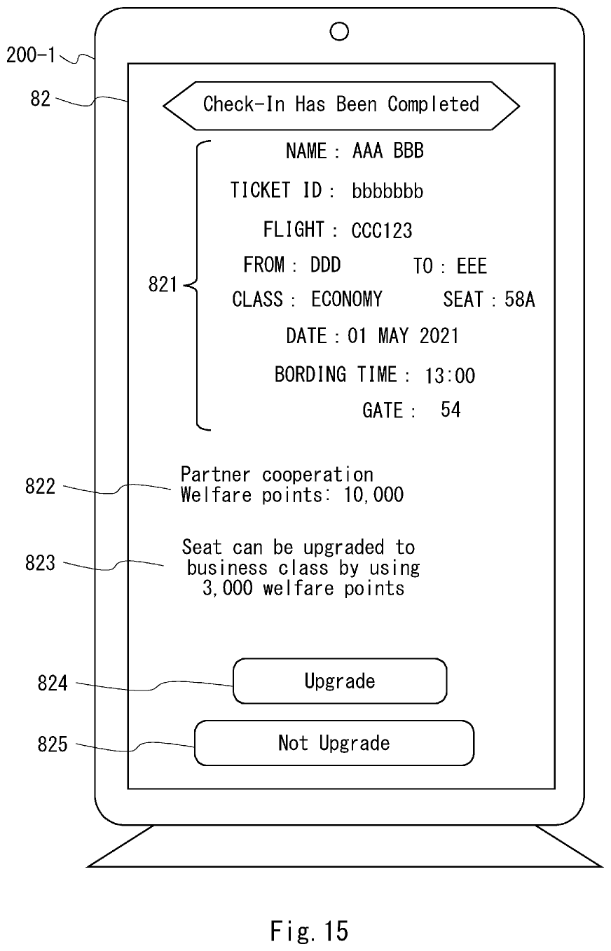

In response to this, the check-in terminal 200-1 displays a notification information display screen image 82. FIG. 15 shows an example of the notification information display screen image 82 according to the second example embodiment. The notification information display screen image 82 includes check-in information 821, welfare points 822, higher service guide information 823, an upgrading button 824, and an un-upgrading button 825. The check-in information 821 is similar to the above-described check-in information 811. In this example, it indicates that the current class of the seat is “ECONOMY”. The welfare points 822 indicate the number of in-house points owned by the user, who has succeeded in the authentication. The higher service guide information 823 is a message for guiding the user to upgrade to a higher service, and includes the number of welfare points that are required (that can be used) for the upgrading. In this example, as the higher service guide information 823, an example of a message that “Seat can be upgraded to business class by using 3,000 welfare points” is shown. When the upgrading button 824 is pressed, information indicating that the user has consented to the content shown by the higher service guide information 823 (upgrading using welfare points) is transmitted to the service processing apparatus 600. When the un-upgrading button 825 is pressed, information indicating that the user has not consented to the content shown by the higher service guide information 823 is transmitted to the service processing apparatus 600. For example, when the user U1 presses the upgrading button 824 displayed on the notification information display screen image 82, the check-in terminal 200-1 transmits information indicating that the user has consented to the content shown by the higher service guide information 823 to the service processing apparatus 600 through the network N. In response to this, the service processing apparatus 600 performs a process for changing the class of the seat for the management system of the airline company including the airline company member DB 300 or the airport. In addition, the service processing apparatus 600 updates the partner corporation employee DB 400 so that points used for the upgrading is subtracted from the in-house points of the user. In the above-described example, the in-house points of the user are updated (i.e., changed) from 10,000 to 7,000.

Other examples of services to be provided include to allow an employee of a partner corporation and his/her family members to use the lounge 702 in the check-in process (i.e., a service at a place different from the check-in area 701 where the authentication has been performed). For example, when the authentication in the check-in terminal 200-1 has succeeded, the determination unit 645 determines, as the service information, a service provided in the lounge 702. Note that the determination unit 645 may change the service level in the lounge according to the partner corporation. Further, the determination unit 645 may change the service level in the lounge according to whether the user U2 is an employee of a partner corporation or his/her family member. Examples of service levels (privilege information) include, but are not limited to, the type of the lounge where the user is permitted to enter, whether only the user who has succeeded in the authentication is permitted to enter the lounge for free or a couple of companions (such as family members) are also permitted, and one free alcoholic drink service for an adult. Then, the processing unit 646 generates notification information including the check-in information, the guide information of the service to be provided in the lounge 702, route information to the lounge 702 and the like, and transmits the generated notification information to the check-in terminal 200-1.

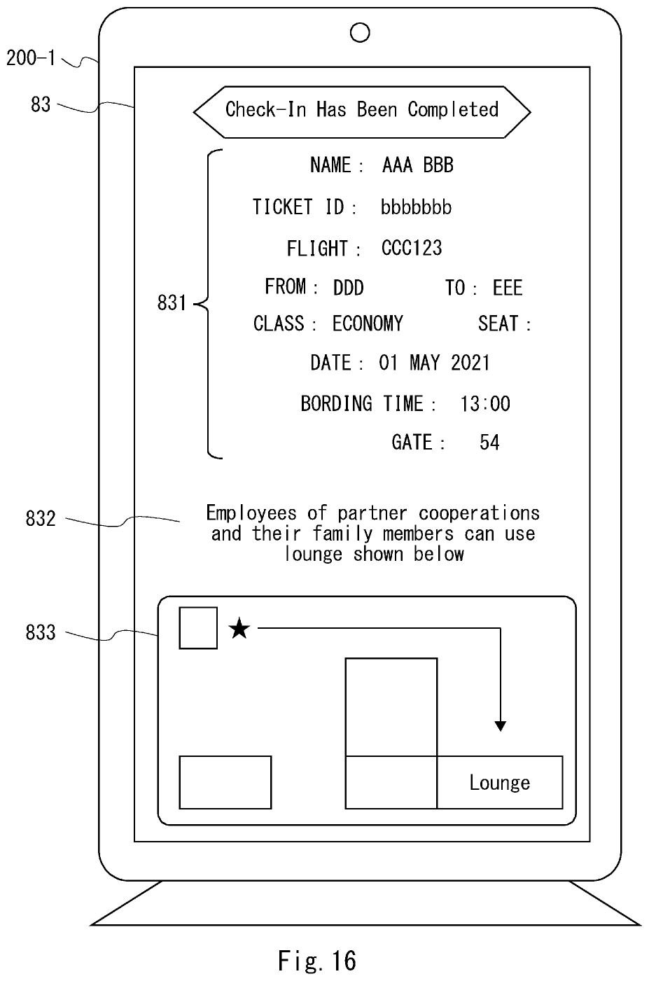

In response to this, the check-in terminal 200-1 displays a notification information display screen image 83. FIG. 16 shows an example of the notification information display screen image 83 according to the second example embodiment. The notification information display screen image 83 includes check-in information 831, guide information 832, and route information 833. The check-in information 831 is similar to the above-described check-in information 811. The guide information 832 is a message for guiding (i.e., indicating) that an employee of a partner corporation and his/her family members can use the lounge 702. In this example, as the guide information 832, an example of a message that “Employees of partner corporations and their family members can use lounge shown below” is shown. The route information 833 is map information showing a route from the current position (first place) to a second place. In this example, as the route information 833, an example of a route from the check-in terminal 200-1 in the check-in area 701 to the entrance of the lounge 702 (place where the entrance terminal 200-2 is installed) is shown. Note that the notification information is not limited to those about the use of a lounge. For example, the service processing apparatus 600 may determine, as notification information, information about stores where discounts are available and information about stores where in-house points can be used. In such a case, the check-in terminal 200-1 may display guide information and route information to a store included in the notification information.

Other examples of services to be provided include to permit an employee of a partner corporation and his/her family members to enter the lounge 702. In this case, it is assumed that the user U2 is present in front of the entrance terminal 200-2 installed at the entrance of the lounge 702. Then, as shown in the above-described FIG. 12, it is assumed that the user U2 has authenticated himself/herself in the entrance terminal 200-2, and the steps S323 to S331 have been performed in the service processing apparatus 600. In this process, the determination unit 645 determines, as the service information, information about a service or a privilege to be provided in the lounge 702. Note that the determination unit 645 may change the service level in the lounge according to the partner corporation. Further, the determination unit 645 may change the service level in the lounge according to whether the user U2 is an employee of a partner corporation or his/her family member. The service level (privilege information) may be similar to that in the above-described example. Then, the processing unit 646 generates notification information including the check-in information, the guide information of the service to be provided in the lounge 702 and the like, and transmits the generated notification information to the entrance terminal 200-2. In addition, the processing unit 646 transmits an instruction to unlock the gate apparatus at the entrance of the lounge 702 to the entrance terminal 200-2.

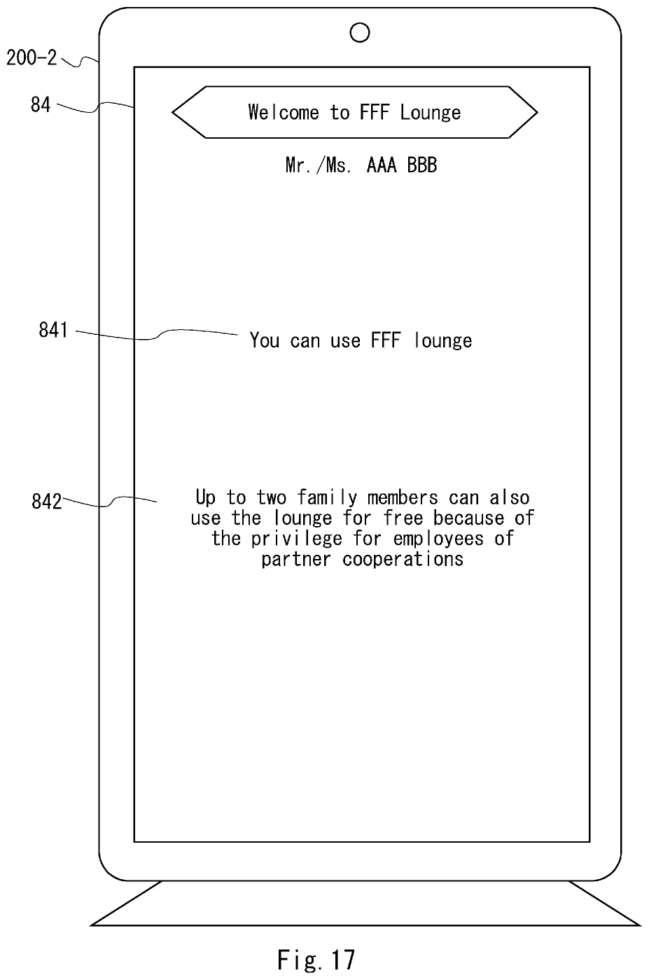

In response to this, the entrance terminal 200-2 displays a notification information display screen image 84. Further, the entrance terminal 200-2 performs control so as to unlock the gate apparatus at the entrance of the lounge 702 in response to the unlocking instruction. FIG. 17 shows an example of the notification information display screen image 84 according to the second example embodiment. The notification information display screen image 84 includes guide information 841 and privilege information 842. The guide information 841 is a message for guiding (i.e., indicating) that an employee of a partner corporation and his/her family members can use the lounge 702. In this example, as the guide information 841, an example of a message that “You can use FFF lounge” is shown. The privilege information 842 indicates a privilege according to, for example, the partner corporation or whether or not the user is an employee of a partner corporation. In this example, as the privilege information 842, an example of a message that “Up to two family members can also use the lounge for free because of the privilege for employees of partner corporations”.

Other examples of services to be provided include a discount service provided to an employee of a partner corporation and his/her family members when they pay for commodities to be purchased in the kiosk 703. In this case, it is assumed that a user U3 has selected commodities in the kiosk 703 and is in front of the store terminal 200-3 to purchase them. Then, as shown in the above-described FIG. 12, it is assumed that the user U3 has authenticated himself/herself at the store terminal 200-3, and steps S323 to S331 have been performed in the service processing apparatus 600. In this process, the determination unit 645 determines, as the service content, a discount rate or a discount amount for reducing the purchasing price of the commodities. Note that the determination unit 645 may change the discount rate and the discount amount according to the partner corporation. For example, the determination unit 645 sets the discount rate to 10% for employees of a corporation A and sets the discount rate to 5% for employees of a corporation B. Further, the determination unit 645 may change the discount rate and the discount amount according to whether the user U3 is an employee of a partner corporation or is his/her family member. For example, the determination unit 645 may set the discount rate to 10% for employees and set the discount rate to 5% for family members of employees. Then, the processing unit 646 generates notification information including, for example, a commodity price (purchasing price to which no discount has not yet been applied), discount information (a discount rate or a discount amount), a price to which the discount has already been applied (hereinafter also referred to as a discounted price), and transmits the generated notification information to the store terminal 200-3.

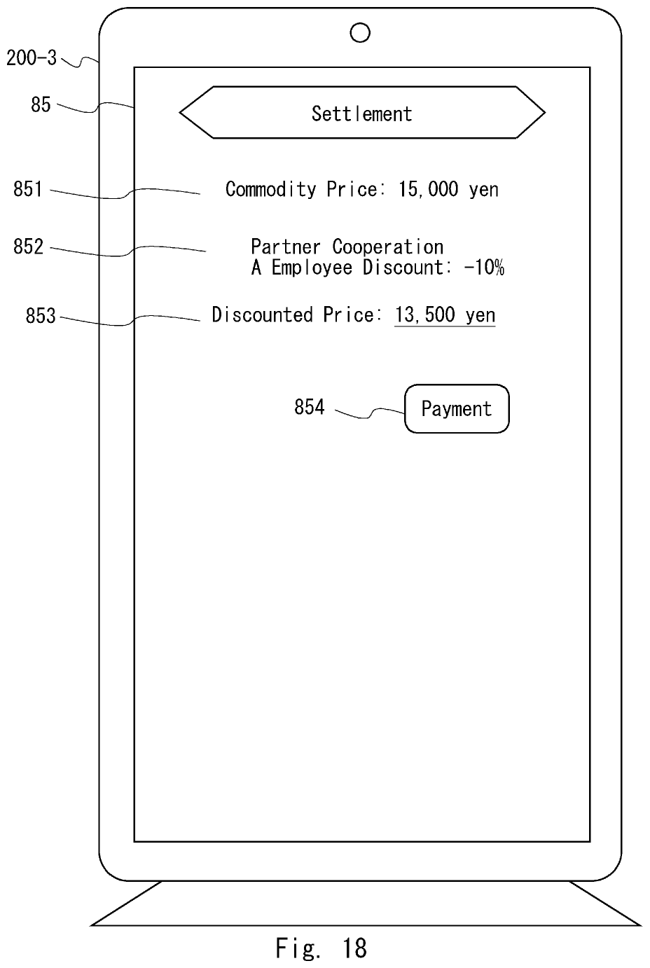

In response to this, the store terminal 200-3 displays a notification information display screen image 85. FIG. 18 shows an example of the notification information display screen image 85 according to the second example embodiment. The notification information display screen image 85 includes a commodity price 851, a partner discount rate 852, a discounted price 853, and a payment button 854. The commodity price 851 indicates the total price for commodities that the user U3 intends to purchase. The commodity price 851 indicates the purchasing price to which the discount (which will be described later) has not yet been applied. Here, an example in which the commodity price 851 is “¥15,000” is shown. The partner discount rate 852 indicates a discount rate that is applied when the user is an employee or the like of a partner corporation. Here, an example in which as the partner discount rate 852, “10%” is reduced from the commodity price 851 because the user is an employee of a partner corporation A is shown. The discounted price 853 indicates the price after the partner discount rate 852 has been applied to the commodity price 851. Here, an example in which the discounted price 853 is “¥13,500” is shown. When the payment button 854 is pressed, a payment process for the discounted price 853 is performed by the store terminal 200-3. Note that when the payment button 854 is pressed, information indicating that the user has consented to the payment for the discounted price 853 or a payment history may be transmitted to the service processing apparatus 600.

Other examples of services to be provided include to provide a discount service using in-house points when an employee of a partner corporation or his/her family member pays money to purchase commodities in the kiosk 703. In this case, it is assumed that the user U3 has selected commodities in the kiosk 703 and is present in front of the store terminal 200-3 to purchase them. Then, as shown in the above-described FIG. 12, it is assumed that the user U3 has authenticated himself/herself in the store terminal 200-3, and steps S323 to S331 have been performed in the service processing apparatus 600. In this process, the determination unit 645 determines, as the service, that the user U3 can reduce the purchasing price by an amount corresponding to some of in-house points 440 associated with the user U3. Then, the processing unit 646 generates notification information including, for example, a commodity price (purchasing price to which no discount has not yet been applied), currently-owned in-house points and the like, and transmits the generated notification information to the store terminal 200-3.

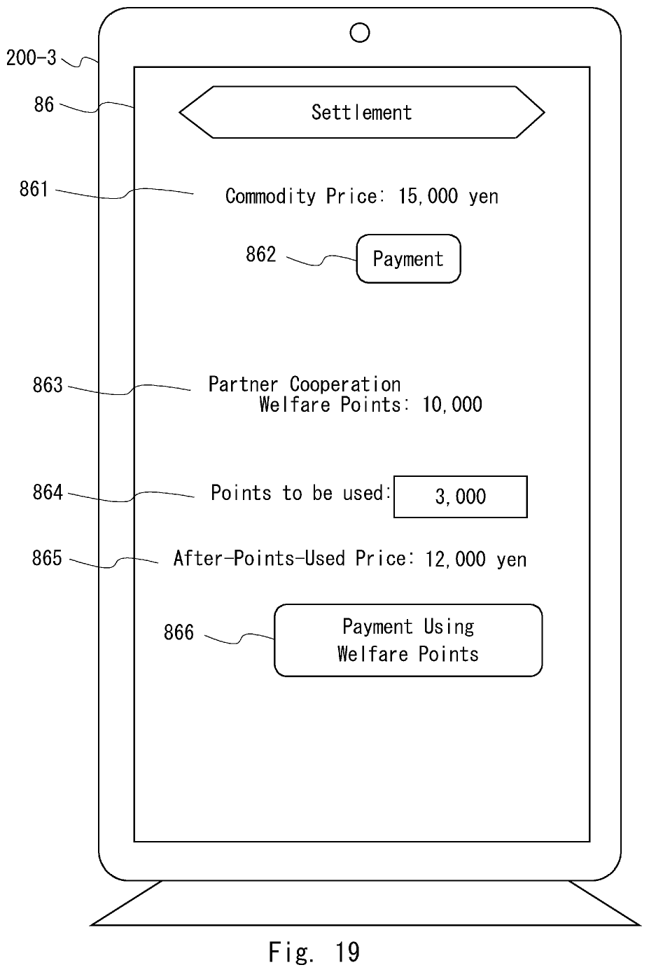

In response to this, the store terminal 200-3 displays a notification information display screen image 86. FIG. 19 shows an example of the notification information display screen image 86 according to the second example embodiment. The notification information display screen image 86 includes a commodity price 861, a payment button 862, welfare points 863, a points-to-be-used input field 864, an after-points-used price 865, and a points-used-payment button 866. The commodity price 861 is similar to the above-described commodity price 851. When the payment button 862 is pressed, a payment process is carried out, by the store terminal 200-3, for the original commodity price 861 without using in-house points (welfare points). The welfare points 863 are similar to the above-described welfare points 822. The points-to-be-used input field 864 is an input field in which, of the welfare points 822, the number of points that the user u3 will use for the payment is entered. Here, an example in which “3,000” points are entered in the points-to-be-used input field 864 is shown. The after-points-used price 865 indicates a price that is obtained by reducing an amount equivalent to the number of points entered in the points-to-be-used input field 864 from the commodity price 861. In this example, it is assumed that welfare points can be used for payment at a rate of one yen per point. Therefore, an example in which “¥12,000”, i.e., a price that is obtained by subtracting 3,000 yen corresponding to “3,000” entered in the points-to-be-used input field 864 is reduced from “¥15,000”, i.e., from the commodity price 861, is displayed in the after-points-used price 865 is shown. When the points-used-payment button 866 is pressed, the store terminal 200-3 performs a payment process with the after-points-used price 865. In addition, when the points-used-payment button 866 is pressed, the store terminal 200-3 transmits the number of points entered in the points-to-be-used input field 864 to the service processing apparatus 600 through the network N. In response to this, the service processing apparatus 600 updates the partner corporation employee DB 400 so that an amount used for the payment is subtracted from the in-house points of the user. In the above-described example, the in-house points of the user are updated (i.e., changed) from 10,000 to 7,000.

Note that the service processing apparatus 600 may transmit the notification information to a terminal or the like other than the check-in terminal 200-1, in which the check-in procedure has been performed, and make this terminal or the like display the transmitted notification information. Note that as described above, examples of the authentication terminal 200 include a digital signage apparatus and a display device with a camera installed in the lounge 702 or the kiosk 703. For example, the digital signage apparatus or the like photographs a user with a camera and transmits an authentication request to the service processing apparatus 600. When the authentication has succeeded, the service processing apparatus 600 may transmit notification information to the digital signage apparatus or the like and make it display the notification information. Further, the notification information may be sent to the user terminal 100. For example, the user terminal 100 may photograph the user who owns (e.g., carries) the user terminal 100 by a built-in camera and internally authenticate the user. When the authentication has succeeded, the user terminal 100 may transmit an authentication result including a user ID to the service processing apparatus 600. Alternatively, the user terminal 100 may transmit an authentication request to the service processing apparatus 600. Alternatively, the user terminal 100 may transmit, instead of the face image of the user, an authentication request including an employee number, a user ID, or the like to the service processing apparatus 600. Note that since the user terminal 100 is owned by the respective user, the authentication is optional. That is, unlocking or the like may be regarded as an authentication success result and it may be transmitted to the service processing apparatus 600.

Note that the service to be provided related to the use of a store is not limited to the above-described examples. For example, when the user, who has succeeded in the authentication in an authentication terminal other than that installed in the store, is an employee or the like of a partner corporation, the service processing apparatus 600 may determine, as the notification information, a guide for a store where a discount can be applied or a guide for a store where in-house points can be used. In such a case, the service processing apparatus 600 transmits the determined notification information to the authentication terminal other than that installed in the store. In this way, this authentication terminal can display the notification information and thereby guide (i.e., introduce) the store to the user. Note that the authentication terminal other than that installed in the store may be, for example, the above-described check-in terminal 200-1, the entrance terminal 200-2, or a digital signage apparatus.

Note that the service to be provided is not limited to those described above. For example, when the service to be provided is to upgrade the service to a higher one, the number of points that are required to upgrade the service to a higher one may be different from one partner corporation to another according to the details of the contract with the airline company (according to the amount of money to be paid to the airline company). Further, when the service to be provided is a permission to use a lounge, the details of the service (e.g., with or without a drink, including or not including alcohol, or a private room being available or not) that the user can use in the lounge may be different from one partner corporation to another. Further, the service to be provided may be changed according to the position or the department in the partner corporation.

Note that as described above, the family information of an employee of a partner corporation, in particular, face images of his/her family members, do not necessarily have to be registered. In such a case, in the service providing process, for example, a family member of an employee of a partner corporation may enter an employee number of the employee into the check-in terminal 200-1, and when it is approved or accepted by the employee, the service for the family member of the employee of the partner corporation may be provided to him/her. Specifically, when the service processing apparatus 600 receives a request including an employee number from the check-in terminal 200-1, it transmits an employee verification request including the employee number to the partner corporation employee DB 400 and then receives a verification result. When the verification result indicates that the person of interest is an employee of the corporation, the service processing apparatus 600 specifies address information of the user terminal of the employee from the employee information included in the verification result. Then, the service processing apparatus 600 transmits a service use verification for the family member to the specified address information. In response to this, the user terminal of the employee receives approval or consent for the received service use verification from the employee, and returns information indicating the approval or consent to the service processing apparatus 600. After that, the service processing apparatus 600 determines service information as described above and transmits notification information to the check-in terminal 200-1. In response to this, the family member is regarded as a family member of the employee of the partner corporation, and hence can receive the service without registering his/her own face image. Note that the check-in terminal 200-1 may photograph a face image of the family member and transmit a request including the face image and the employee number to the service processing apparatus 600. In this case, the service processing apparatus 600 transmits the face image of the family member to the specified address information, i.e., to the user terminal of the employee. Then, when the service processing apparatus 600 receives approval or the like from the employee, it provides the service to the family member. Note that the above-described feature can also be applied when a service is provided through an authentication terminal 200 other than the check-in terminal 200-1.

It should be noted that there is a limit for a business operator who provides services to members (users) to whom services are to be provided to increase the number of members by the business operator alone, or to manage information of members who belong to various organizations and induce them to use services according to the organization.

For this matter, it is possible to easily increase the number of members of a business operator as a corporation group that already manages employee information of a considerable number of employees and their family members cooperates with a business operator, and thereby cooperating in regard to their membership information. In addition, even if the business operator does not manage detailed information of employees of the partner corporation(s), the business operator can provide elaborate services to each user by using the employee information of the corporation group. Further, it is possible to protect the privacies of employees and the like of the partner corporation(s).

By linking a DB managed by a business operator who provides services and a DB managed by a partner corporation of the business operator by using IDs as described above in this example embodiment, the business operator can easily use information about affiliated members of the partner corporation and provide appropriate services to the affiliated members. In the above-described example, the linkage between IDs is realized by associating the airline company member DB 300 with the partner corporation employee DB 400 by associating member IDs 6121 with user IDs 6122 (or employee numbers 410) by cooperative information 612 stored in the service processing apparatus 600. Therefore, as an airline company cooperates with a specific corporation, it can not only increase its own members by itself but also easily provide services to employees belonging to the corporation. However, the method for realizing the linkage between IDs is not limited to this example.

Further, in this example embodiment, by notifying a user, who has succeeded in the authentication, of notification information about a determined service, the user can easily and appropriately recognize the service that will be provided to him/her. In particular, when the notification information is a guide (recommendation) for the service, the user can determine and/or designate whether or not he/she can use the guided service and how much he/she will use the guided service (e.g., how many points he/she will use) by himself/herself. Further, since a service that will be provided in a place different from the current place is guided by the notification information, the use of the service is promoted. Further, the service contents and service levels can be adjusted as appropriate according to the affiliation information (such as the position, the department, and years of service) and the family attribute managed on the partner corporation side, so that the usability on the business operator side is high. Further, the service contents and service levels can be adjusted as appropriate according to the partner corporation, so that the provision of services and service levels can be adjusted in an elaborated manner according to the partnership contract, so that the usability on the business operator side is high. Further, since in-organization privilege information in the partner corporation can be used for services, the usability is also high for employees (affiliated members) of the partner corporation, so that the use of services is promoted. Further, since services can also be provided to family members of employees of the partner corporation, the usability is also high for the family members of the employees of the partner corporation, so that the use of services is promoted. Further, a history in regard to the recode of use of services and/or a result of an analysis can be provided to outside parties or the like, so that they can be used for marketing.

Note that although identity authentication is performed by using face authentication in the above-described service providing process shown in FIG. 12, it is not limited to this example. For example, the identity authentication process may be performed by using passport information, code information (such as a 2D code) displayed on an airline ticket voucher, a reservation number, a confirmation number, a card number (member ID) recorded in a magnetic code or an IC chip of a membership card of an airline company, or the like. For example, the check-in terminal 200-1 reads a 2D code printed on an airline ticket voucher presented by a user U1, analyzes the 2D code, and acquires airline ticket information (such as a ticket ID, a reservation number, or a confirmation number). Alternatively, the check-in terminal 200-1 may acquire a reservation number and a confirmation number entered on a screen by a user U1. Alternatively, the check-in terminal 200-1 may read a magnetic code from a membership card or read a card number or the like embedded in an IC chip through contactless wireless communication. Then, in the step S322, the check-in terminal 200-1 transmits, as an authentication request, the acquired ticket ID, the reservation number, the confirmation number, and the card number to the service processing apparatus 600. In this process, the service processing apparatus 600 does not perform the steps S323 to S325, but performs the steps S327 and S328. That is, the service processing apparatus 600 transmits a membership verification request including the received information to the airline company member DB 300, and thereby verifies that the user is a member of the airline company or that the ticket has already been reserved, or verifies the member ID or the like. After that, the service processing apparatus 600 specifies a user ID 6122 associated with the member ID 6121 from the cooperative information 612. Then, the service processing apparatus 600 performs the step S329 and the subsequent steps.

Alternatively, the identity authentication process may be performed as follows. Firstly, (1) the check-in terminal 200-1 acquires passport information recorded in an IC chip of a passport presented by a user U1 through near-field wireless communication or the like. Note that the passport information includes a nationality, a country that issued the passport, a passport number (individual identification information), an expiration date, and face data (face image or face feature information) of the user. In addition, (2) the check-in terminal 200-1 acquires airline ticket information from a ticket voucher as described above. Next, (3) the check-in terminal 200-1 photographs the face of the user. Then, (4) the check-in terminal 200-1 compares the face data included in the passport information with the photographed face image. (5) When the comparison has succeeded, the check-in terminal 200-1 transmits a check-in request including the face data and the airline ticket information to the service processing apparatus 600. (6) The service processing apparatus 600 registers the face data included in the received check-in request and the airline ticket information in association with each other, and performs a check-in process. Then, (7) the service processing apparatus 600 performs the step S326 and the subsequent steps. Note that upon receiving an input of corporation information (such as an employee number) to which the user belongs from the user, the service processing apparatus 600 may determine whether or not the user is an employee of a partner corporation (S329 and S330). Further, when the passport information (at least the passport number) and the airline ticket information are registered in association with each other in advance, the above-described Item (2) may be omitted (or skipped). Further, the same applies when the face data and the airline ticket information are registered in association with each other in advance as the passport information.

Alternatively, the identity authentication process may be performed by using an employee number or a user ID recorded in an IC chip of an employee identification card. For example, it is assumed that information of an employer identification card, in particular, an employee number and a user ID (issued and registered in the authentication apparatus 500) are recorded in an IC chip in a user terminal of a user U1. In this case, the check-in terminal 200-1 may acquire the employee number or the like from the user terminal of the user U1 through near-field wireless communication. Then, in the step S322, the check-in terminal 200-1 transmits, as an authentication request, the acquired employee number or the user ID to the service processing apparatus 600. When the employee number is included in the authentication request, the service processing apparatus 600 does not perform the steps S323 to S325, but acquires the user ID based on the employee number as shown in the steps S316 and S317 in FIG. 11. Then, the service processing apparatus 600 performs the step S326 and the subsequent steps. Further, when the member ID 6121 is associated with the employee number in the cooperative information 612, the service processing apparatus 600 does not perform the steps S323 to S325, but can specify the member ID associated with the employee number from the cooperative information 612 in the step S326. Alternatively, when the user ID is included in the authentication request, the service processing apparatus 600 does not perform the steps S323 to S325, but performs the step S326 and the subsequent steps. As described above, the identity authentication process can be implemented in any of various ways.

Further, a user of the service processing system 1000 according to this example embodiment does not necessarily have to have a reservation for an airline ticket. For example, the system or the like may be applied to a person who come to the airport 700 to see someone (e.g., a friend) off. In this case, the steps S327 and S328 shown in FIG. 12 may be omitted (or skipped).

Note that an airline company may conclude a contract with a partner corporation according to which the airline company provides a complimentary service to an employee of the partner corporation and his/her family members. Then, the partner corporation may pay the airline company a fixed amount of money for the complimentary service and a pay-as-you-go amount of money based on the number of services they used. The partner corporation may provide such services to its employees and the like as part of welfare (such as employee discounts) for the employees and the like.

Note that the service processing system 1000 according to this example embodiment can be applied to, in addition to airports, theme parks, hotels, restaurants, and the like.

Note that the service processing system 1000 according to this example embodiment may provide services even when the user is not a member of a business operator (e.g., a specific airline company), as long as the user is a member of a partner corporation or the like. In such a case, for example, when it is determined, in the above-described FIG. 12, that the face authentication has succeeded based on the face authentication result in the step S325, the process for verifying an employee or the like of the partner corporation is performed (steps S329 and S330) without performing the process for verifying a member of the business operator (steps S326 to S328). Then, when the user is an employee or the like of the partner corporation, the process may proceed to the step S331 and the subsequent steps, and hence a service is provided to the user. As a result, the employee or the like of the partner corporation is saved from having to register him/her as a member of the business operator and still benefits from a service of the business operator, so that the use of the service is promoted. In particular, in the case where the face information of an employee of the partner corporation or his/her family member is not registered, it is sufficient if he/she registers his/her face information (or other identity authentication information) in the DB on the corporation side, the registration of identity authentication information in the authentication base can be promoted (or accelerated), thereby contributing to the spread of the authentication service. Further, the process for verifying a member of a business operator can be omitted (i.e., eliminated) in the service providing process, so that the process can be made faster.

Further, the service processing system 1000 according to this example embodiment may provide a service as long as the user is a member of a partner corporation irrespective of whether the member is a member of the business operator or not. Even in such a case, the system or the like can be implemented through processes similar to the above-described processes. Alternatively, in the above-described FIG. 12, after the step S325, the steps S329 and S330 are performed first, and no service is provided when the user is not an employee or the like. On the other hand, when the user is an employee or the like of a partner corporation in the step S330, the steps S326 to S328 may be performed. Alternatively, even when the user is not a member of a business operator in the process for verifying a member of the business operator in the above-described FIG. 12, the process may proceed to the process for verifying an employee or the like of the partner corporation. In such a case, the service level may be changed according to whether or not the user is a member of the business operator, or according to the membership rank or the like.

Further, after the step S325 in the above-described FIG. 12, the process for verifying a member of the business operator (steps S326 to S328) and the process for verifying an employee or the like of the partner corporation (steps S329 and S330) may be performed independently of each other and in parallel with each other. Alternatively, after the step S325 in the above-described FIG. 12, the process for verifying an employee or the like of the partner corporation may be performed first, and when it is verified that the user is an employee of the partner corporation, the process for verifying a member of the business operator may be performed. In any of the cases, when it is verified that the user is an employee or the like of a partner corporation, the service level may be changed according to whether or not the employee is a member of the business operator or according to the membership rank or the like.

Further, it may be verified that the user is an employee or the like of a partner corporation in response to a declaration that the user is an employee or the like of the partner corporation, or an answer to an inquiry to the user. For example, when a statement or the like that a user is an employee or the like of a partner corporation from the user is input to the authentication terminal 200, the service processing apparatus 600 performs a process for verifying an employee or the like of the partner corporation along with the process for verifying a member of the business operator. Alternatively, when the user cannot be verified as a member of the business operator in the step S326 or S328 in FIG. 12, the service processing apparatus 600 may inquire of the user whether he/she is an employee or the like of a partner corporation. Specifically, the service processing apparatus 600 transmits an inquiry as to whether the user is an employee or the like of a partner corporation to the authentication terminal 200, and after receiving an answer that the user is an employee or the like, performs a process for verifying that the user is an employee or the like of a partner corporation. Alternatively, when a user can be verified as a member of a business operator, the service processing apparatus 600 may inquire of the user whether he/she is an employee or the like of a partner corporation.

### Other Example Embodiment

Note that although the service processing apparatus 600 and the authentication apparatus 500 are separate information processing apparatuses in the above-described second example embodiment, they may be the same apparatus or the like (i.e., implemented by one apparatus). For example, the service processing apparatus 600 may further associate face feature information with the user ID 6122 included in the cooperative information 612 and register them. In such a case, the control unit 640 may further include the functions of the face detection unit 520, the feature point extraction unit 530, the registration unit 540, and the authentication unit 550 shown in FIG. 7. Alternatively, the partner corporation employee DB 400 may further associate face feature information with the user ID 420 and register them.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present disclosure is not limited to the above-described example embodiments and various changes may be made therein without departing from the spirit and scope of the present disclosure. Further, the present disclosure may be implemented by combining example embodiments with one another.

The whole or part of the example embodiments disclosed above can be described as, but not limited to, the following supplementary notes.

### (Supplementary Note A1)

A service processing apparatus comprising:
authentication control means for referring to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
specifying means for specifying an organization to which the user belongs based on a fact that the authentication has succeeded;
determination means for determining a service that the business operator provides according to the specified organization; and
processing means for performing processing according to the determined service.

### (Supplementary Note A2)

The service processing apparatus described in Supplementary note A1, wherein the processing means notifies the user of notification information about the determined service.

### (Supplementary Note A3)

The service processing apparatus described in Supplementary note A2, wherein
the authentication control means controls authentication that is performed based on the identity authentication information acquired by the authentication terminal installed in a first place of the facility,
the determination means determines a service that the business operator will provide in a second place of the facility, and
the processing means notifies the authentication terminal of the notification information indicating that the determined service can be used in the second place.

### (Supplementary Note A4)

The service processing apparatus described in Supplementary note A3, wherein the processing means notifies the authentication terminal of the notification information further including route information from the first place to the second place.

### (Supplementary Note A5)

The service processing apparatus described in any one of Supplementary notes A1 to A4, wherein
affiliation information of an organization to which the affiliated member belongs and the identity authentication information of the affiliated member are registered in association with each other in the database, and
the determination means determines the service according to the affiliation information associated with the identity authentication information for which the authentication has succeeded.

### (Supplementary Note A6)

The service processing apparatus described in any one of Supplementary notes A1 to A5, wherein
in-organization privilege information given in the organization and the identity authentication information of the affiliated member are registered in association with each other in the database, and
the determination means determines the service while taking the in-organization privilege information associated with the identity authentication information for which the authentication has succeeded into consideration.

### (Supplementary Note A7)

The service processing apparatus described in Supplementary note A6, wherein the processing means notifies the user that the in-organization privilege information can be used for payment of a usage fee for the determined service.

### (Supplementary Note A8)

The service processing apparatus described in Supplementary note A6 or A7, wherein
the determination means further determines a higher service which is higher than a current service level, and which the user can use by using the in-organization privilege information, and
the processing means notifies the user that he/she can use the determined higher service by using the in-organization privilege information.

### (Supplementary Note A9)

The service processing apparatus described in any one of Supplementary notes A1 to A8, wherein
identity authentication information of a family member of the affiliated member and a family attribute indicating the user is the family member of the affiliated member are registered in association with each other in the database, and
when the family attribute is associated with the identity authentication information for which the authentication has succeeded, the specifying means specifies an organization to which the affiliated member corresponding to the family attribute belongs.

### (Supplementary Note A10)

The service processing apparatus described in Supplementary note A9, wherein when the organization to which the affiliated member indicated by the family attribute belongs is specified, the determination means determines the service having a service level different from that for the affiliated member.

### (Supplementary Note A11)

The service processing apparatus described in any one of Supplementary notes A1 to A10, wherein the processing means externally outputs information based on a record of use of the service provided to the user.

### (Supplementary Note A12)

The service processing apparatus described in any one of Supplementary notes A1 to A11, wherein the determination means determines the service together with privilege information related to a usage fee.

### (Supplementary Note B1)

A service processing system comprising:
a database in which identity authentication information of affiliated members of a partner organization of a business operator who provides a predetermined service in a predetermined facility is registered; and
an authentication terminal installed in the facility; and
a service processing apparatus, wherein
the service processing apparatus comprises:
authentication control means for referring to the database and controlling authentication that is performed based on identity authentication information of a user of the facility acquired by the authentication terminal;
specifying means for specifying an organization to which the user belongs based on a fact that the authentication has succeeded;
determination means for determining a service that the business operator provides according to the specified organization; and
processing means for performing processing according to the determined service.

### (Supplementary Note B2)

The service processing system described in Supplementary note B1, wherein the processing means notifies the user of notification information about the determined service.

### (Supplementary Note C1)

A service processing method comprising:
referring, by a computer, to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
specifying, by the computer, an organization to which the user belongs based on a fact that the authentication has succeeded;
determining, by the computer, the service that the business operator provides according to the specified organization; and
performing, by the computer, processing according to the determined service.

### (Supplementary Note D1)

A non-transitory computer readable medium storing a service processing program for causing a computer to perform:
a process for referring to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
a process for specifying an organization to which the user belongs based on a fact that the authentication has succeeded;
a process for determining a service that the business operator provides according to the specified organization; and
a process for performing processing according to the determined service.

Although the present invention has been described with reference to example embodiments (and examples), the present invention is not limited to the above-described example embodiments (and examples). The configuration and details of the present invention may be modified within the scope of the present invention in various ways that can be understood by those skilled in the art.

### REFERENCE SIGNS LIST

1 SERVICE PROCESSING APPARATUS
11 AUTHENTICATION CONTROL UNIT
12 SPECIFYING UNIT
13 DETERMINATION UNIT
14 PROCESS UNIT
1000 SERVICE PROCESSING SYSTEM
U0 USER
U1 USER
U2 USER
N NETWORK
100 USER TERMINAL
200 AUTHENTICATION TERMINAL
200-1 CHECK-IN TERMINAL
200-2 ENTRANCE TERMINAL
200-3 STORE TERMINAL
210 CAMERA
220 STORAGE UNIT
221 PROGRAM
230 MEMORY
240 COMMUNICATION UNIT
250 INPUT/OUTPUT UNIT
260 CONTROL UNIT
261 DISPLAY CONTROL UNIT
262 AUTHENTICATION REQUEST UNIT
263 PROCESS CONTROL UNIT
300 AIRLINE COMPANY MEMBER DB
310 MEMBER ID
320 PERSONAL INFORMATION
330 MEMBERSHIP RANK
340 CURRENTLY-OWNED POINT
350 AIRLINE TICKET INFORMATION
400 PARTNER CORPORATION EMPLOYEE DB
410 EMPLOYEE NUMBER
420 USER ID
430 EMPLOYEE INFORMATION
440 IN-HOUSE POINT
450 FAMILY INFORMATION
451 USER ID
452 FAMILY ATTRIBUTE
500 AUTHENTICATION APPARATUS
510 FACE INFORMATION DB
511 USER ID
512 FACE FEATURE INFORMATION
520 FACE DETECTION UNIT
530 FEATURE POINT EXTRACTION UNIT
540 REGISTRATION UNIT
550 AUTHENTICATION UNIT
600 SERVICE PROCESSING APPARATUS
610 STORAGE UNIT
611 PROGRAM
612 COOPERATIVE INFORMATION
6121 MEMBER ID
6122 USER ID
613 SERVICE DEFINITION INFORMATION
6131 PARTNER
6132 SERVICE INFORMATION
61321 LEVEL
61322 CONTENT
620 MEMORY
630 COMMUNICATION UNIT
640 CONTROL UNIT
641 REGISTRATION UNIT
642 AUTHENTICATION CONTROL UNIT
643 DETERMINATION UNIT
644 SPECIFYING UNIT
645 DETERMINATION UNIT
646 PROCESS UNIT
700 AIRPORT
701 CHECK-IN AREA
702 LOUNGE
703 KIOSK
81 NOTIFICATION INFORMATION DISPLAY SCREEN IMAGE
811 CHECK-IN INFORMATION
812 EARNED POINT
813 POINT BREAKDOWN
82 NOTIFICATION INFORMATION DISPLAY SCREEN IMAGE
821 CHECK-IN INFORMATION
822 WELFARE POINT
823 HIGHER SERVICE GUIDE INFORMATION
824 UPGRADING BUTTON
825 UN-UPGRADING BUTTON
83 NOTIFICATION INFORMATION DISPLAY SCREEN IMAGE
831 CHECK-IN INFORMATION
832 GUIDE INFORMATION
833 ROUTE INFORMATION
84 NOTIFICATION INFORMATION DISPLAY SCREEN IMAGE
841 GUIDE INFORMATION
842 PRIVILEGE INFORMATION
85 NOTIFICATION INFORMATION DISPLAY SCREEN IMAGE
851 COMMODITY AMOUNT
852 PARTNER COMPANY DISCOUNT RATE
853 DISCOUNTED AMOUNT
854 SETTLEMENT BUTTON
86 NOTIFICATION INFORMATION DISPLAY SCREEN IMAGE
861 COMMODITY AMOUNT
862 SETTLEMENT BUTTON
863 WELFARE POINT
864 USED POINT INPUT FIELD
865 POINT-USED AMOUNT
866 POINT-USED SETTLEMENT BUTTON

What is claimed is:

1. A service processing apparatus comprising:
at least one memory storing instructions; and
at least one processor configured to execute the instructions to:
refer to a database in which identity authentication information of affiliated members of a partner organization of a business operator who provides a predetermined service in a predetermined facility is registered, and control authentication that is performed based on identity authentication information of a user of the facility acquired by an authentication terminal installed in the facility;
specify an organization to which the user belongs based on a fact that the authentication has succeeded;
determine a service that the business operator provides according to the specified organization; and
perform processing according to the determined service.

2. The service processing apparatus according to claim 1, wherein the at least one processor is further configured to execute the instructions to:
notify the user of notification information about the determined service.

3. The service processing apparatus according to claim 2, wherein the at least one processor is further configured to execute the instructions to:
control authentication that is performed based on the identity authentication information acquired by the authentication terminal installed in a first place of the facility,
determine a service that the business operator will provide in a second place of the facility, and
notify the authentication terminal of the notification information indicating that the determined service can be used in the second place.

4. The service processing apparatus according to claim 3, wherein the at least one processor is further configured to execute the instructions to:
notify the authentication terminal of the notification information further including route information from the first place to the second place.

5. The service processing apparatus according to claim 1, wherein
affiliation information of an organization to which the affiliated member belongs and the identity authentication information of the affiliated member are registered in association with each other in the database, and
the at least one processor is further configured to execute the instructions to:
determine the service according to the affiliation information associated with the identity authentication information for which the authentication has succeeded.

6. The service processing apparatus according to claim 1, wherein
in-organization privilege information given in the organization and the identity authentication information of the affiliated member are registered in association with each other in the database, and
the at least one processor is further configured to execute the instructions to:
determine the service while taking the in-organization privilege information associated with the identity authentication information for which the authentication has succeeded into consideration.

7. The service processing apparatus according to claim 6, wherein the at least one processor is further configured to execute the instructions to:
notify the user that the in-organization privilege information can be used for payment of a usage fee for the determined service.

8. The service processing apparatus according to claim 6, wherein the at least one processor is further configured to execute the instructions to:
determine a higher service which is higher than a current service level, and which the user can use by using the in-organization privilege information, and
notify the user that he/she can use the determined higher service by using the in-organization privilege information.

9. The service processing apparatus according to claim 1, wherein
identity authentication information of a family member of the affiliated member and a family attribute indicating the user is the family member of the affiliated member are registered in association with each other in the database, and
the at least one processor is further configured to execute the instructions to:
specify, when the family attribute is associated with the identity authentication information for which the authentication has succeeded, an organization to which the affiliated member corresponding to the family attribute belongs.

10. The service processing apparatus according to claim 9, wherein the at least one processor is further configured to execute the instructions to:
determine, when the organization to which the affiliated member indicated by the family attribute belongs is specified, the service having a service level different from that for the affiliated member.

11. The service processing apparatus according to claim 1, wherein the at least one processor is further configured to execute the instructions to:
externally output information based on a record of use of the service provided to the user.

12. The service processing apparatus according to claim 1, wherein the at least one processor is further configured to execute the instructions to:
determine the service together with privilege information related to a usage fee.

13. A service processing system comprising:
a database in which identity authentication information of affiliated members of a partner organization of a business operator who provides a predetermined service in a predetermined facility is registered; and
an authentication terminal installed in the facility; and
a service processing apparatus, wherein
the service processing apparatus comprises:
at least one memory storing instructions; and
at least one processor configured to execute the instructions to:
refer to the database and control authentication that is performed based on identity authentication information of a user of the facility acquired by the authentication terminal;
specify an organization to which the user belongs based on a fact that the authentication has succeeded;
determine a service that the business operator provides according to the specified organization; and
perform processing according to the determined service.

14. The service processing system according to claim 13, wherein the at least one processor is further configured to execute the instructions to:
notify the user of notification information about the determined service.

15. A service processing method comprising:
referring, by a computer, to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
specifying, by the computer, an organization to which the user belongs based on a fact that the authentication has succeeded;
determining, by the computer, the service that the business operator provides according to the specified organization; and
performing, by the computer, processing according to the determined service.

16. A non-transitory computer readable medium storing a service processing program for causing a computer to perform:
a process for referring to a database in which identity authentication information of affiliated members of a partner organization of a business operator who provides a predetermined service in a predetermined facility is registered, and controlling authentication that is performed based on identity authentication information of a user of the facility acquired by an authentication terminal installed in the facility;
a process for specifying an organization to which the user belongs based on a fact that the authentication has succeeded;
a process for determining a service that the business operator provides according to the specified organization; and
a process for performing processing according to the determined service.
